(19) United States
(12) Patent Application Publication
(10) Pub. No.: US 2026/0245106 A1
(43) Pub. Date: Aug. 20, 2026

(54) MULTI-TOUCH ATTRIBUTION

(71) Applicant: Claritas, LLC, Cincinnati, OH (US)

(72) Inventor: Jason Rex Briggs, Galena Forrest, NV (US)

(21) Appl. No.: 19/538,409

(22) Filed: Feb. 12, 2026

Related U.S. Application Data
(60) Provisional application No. 63/758,949, filed on Feb. 14, 2025.

(51) Int. Cl. G06Q 30/0201; G06Q 30/0241; G06Q 30/0242; G06Q 30/0251

(52) U.S. Cl. CPC G06Q 30/0201; G06Q 30/0246; G06Q 30/0251; G06Q 30/0277

(57) ABSTRACT

A method comprising receiving, from a tracking pixel associated with a KPI, tracking data comprising a plurality of tags, wherein the KPI is associated with an entity, wherein a first tag is associated with the entity, and wherein a second tag is associated with a second entity. The plurality of tags can be normalized based on a reach. An incrementality count corresponding to the first is determined using a post-hoc comparative analysis, based on a comparison of a first conversion rate associated with the first tag and a second conversion associated with the second tag. A spillover effect and/or a lost signal measurement are determined for the first tag. An attribution measurement is determined by applying the spillover effect and/or the lost signal measurement to the incrementality count. At least one of the attribution measurement or the incrementality count is provided to a user device.

### RELATED APPLICATION

This application claims the benefit under 35 U.S.C. § 119(e) of U.S. Provisional Patent Application No. 63/758,949, titled “Mutli-Touch Attribution,” filed on Feb. 14, 2025, the entire content of which his incorporated herein by reference.

### TECHNICAL FIELD

This disclosure relates to the field of artificial intelligence, and in particular to determining multi-touch attribution.

### BACKGROUND

Attribution can be an important component of assessing the effectiveness of actions or events that contribute to a desired outcome. In many industries, including marketing and content distribution, attribution can involve determining which channels, interactions, or campaigns are responsible for achieve specific results, such as conversions, revenue generation, or user engagement.

Some attribution methods often rely on rule-based models, such as last-click or first-click attribution. These models attribute all or most of the credit for an outcome to a single interaction or event. While simple to implement, such approaches fail to account for the multifaceted and interconnected nature of modern systems. For example, in digital marketing, customers often interact with multiple touchpoints, such as email campaigns, social media advertisements, and website interactions, before making a purchase decision. Failing to account for the combined contributions of these touchpoints results in incomplete or inaccurate attribution.

### BRIEF DESCRIPTION OF THE DRAWINGS

The present disclosure will be understood more fully from the detailed description given below and from the accompanying drawings of various embodiments of the present disclosure, which, however, should not be taken to limit the present disclosure to the specific embodiments, but are for explanation and understanding only.

FIG. 1 illustrates an example of a system architecture for implementations of the present disclosure.

FIG. 2 depicts a flow diagram of a method for determining multi-touch attribution, in accordance with one or more aspects of the present disclosure.

FIG. 3 illustrates a diagram showing the relationship between a KPI pixel and multiple tags associated with the KPI pixel, in accordance with one or more aspects of the present disclosure.

FIG. 4 depicts a diagram illustrating a campaign reach visualization for multi-touch attribution, in accordance with one or more aspects of the present disclosure.

FIG. 5 depicts a scatter chart illustrating the relationship between attribution shar and incrementality share, in accordance with one or more aspects of the present disclosure.

FIG. 6A depicts a frequency lift response function graph illustrating the relationship between advertising frequency and cumulative lift, in accordance with one or more aspects of the present disclosure.

FIG. 6B depicts a graph illustrating a frequency to lift response function for multi-touch attribution, in accordance with one or more aspects of the present disclosure

FIG. 7 is a block diagram of a system for artificial intelligence model training and inference for multi-touch attribution, in accordance with one or more aspects of the present disclosure.

FIG. 8 depicts a block diagram of an example computing system operating in accordance with one or more aspects of the present disclosure.

### DETAILED DESCRIPTION

Embodiments are described for determining multi-touch attribution and incrementality. Attribution can refer to the opportunity of advertising exposures to influence a conversion, where the conversion may be connected to one or more advertising impressions that occurred prior to the conversion event within a lookback window. Attribution can show the touchpoints at which a consumer was exposed to promotional messages and subsequently converted. In multi-touch attribution, credit for a conversion can be distributed across multiple advertising exposures (touches) that a consumer experienced prior to the conversion event, rather than assigning all credit to a single touch (such as the last touch or first touch). Attribution can help advertisers determine if sufficient conversions were generated to warrant continued advertising, and may be used to compare different messages, placements, and/or audiences in terms of performance, in embodiments. Incrementality can refer to the increase in conversions that would not have occurred but for the advertising impressions. Incrementality can represent the subset of attributable conversions that were caused by the advertisement, excluding baseline conversions that would have occurred even without advertising exposure. Incrementality can be measured by comparing the conversion rate of users exposed to the advertiser's campaign against the conversion rate of a control group (users exposed to placebo/control advertisements from concurrent campaigns), with the difference representing the incremental effect of the advertising, in embodiments.

Historically, a consumer's interactions with marketing campaigns has been relatively easy to track. For example, when consumers accessed the internet from a single device, it was relatively easy to connect a conversion event to advertisement exposures because the ad impression and subsequent purchase could be easily associated through a consistent identifier, such as a home IP address or logged-in user ID. However, as consumers' interactions with marketing campaigns has evolved to include a multitude of devices (e.g., personal computers, cell phones, tablets, etc.) connected to various channels (e.g., cell service, public and/or private wi-fi signals, etc.), determining an accurate attribution for marketing campaigns has become increasingly difficult. Many of the touchpoints of a campaign can end up getting lost and not counted in attribution. To address this challenge, some entities have adopted simplified approaches that do not require tracking all touchpoints. For example, some entities use ascription rather than attribution to attribute credit to certain marketing campaigns. Ascription involves assigning weight to touches based on rules, such as linearly assigning more weight to the “last touch” connection that led to a key performance indicator (KPI) event. This approach may underweight prior touches, which have a decreasing weight based on a time based decay rule. Or, some entities use an entirely last touch attribution, which ignores the previous connection points with the consumer. As used herein, a “key performance indicator” or “KPI” refers to a measurable metric that an advertiser uses to evaluate the success of an advertising campaign. A KPI can correspond to a conversion event. As used herein, a “conversion event” refers to a specific action taken by a consumer that aligns with the goals of an advertisement campaign or promotional cycle. A conversion event can be, for example, making a purchase (e.g., online or offline), filing out a contact form, subscribing to a newsletter, downloading an application (e.g., on a smartphone), content engagement (e.g., watching a video, clicking a link, downloading a resource, such as an e-book), spending a certain amount of time on a webpage, completing a survey, signing up for a webinar, event, or a free trial, registering for an application, or any other measurable action that an advertiser defines as a desired outcome. The term “conversion event” may be used interchangeably with “KPI event” throughout this disclosure. While ascription is easier to calculate, it is not an accurate attribution measurement.

Aspects of the present disclosure address the above-noted and other deficiencies by providing a system and method to measure multi-touch attribution that includes digital, broadcast, direct mail, and/or other types of connections in a marketing campaign. As used herein, a “touch” or “touchpoint” refers to an instance in which a consumer is exposed to an advertisement or promotional message prior to a conversion event. A touch can include, for example, viewing a digital display advertisement, watching a video advertisement, listening to an audio advertisement (such as a podcast or broadcast advertisement), receiving a direct mail piece, or any other exposure to promotional content. In multi-touch attribution, a consumer may be exposed to multiple touches across different channels, devices, and time periods before performing a conversion event, and each touch can be represented by a tag associated with a tracking pixel. The multi-touch attribution (MTA) measurement described herein can be determined using a post-hoc randomized controlled test (PHRCT) and/or post-hoc quasi-experimental design (PHQED) that combines artificial intelligence (AI) incrementality predictions with experimental design. In some embodiments, the PHRCT and/or PHQED can act as a secondary check on the AI incrementality results, ensuring statistical significance. That is, the PHRCT and/or PHQED confirms that an advertiser's advertising events outperform placebo advertisements, providing rigorous evidence of campaign impact. By combining AI-based prediction with quasi-experimental validation, the MTA measurement techniques described throughout offer a holistic, multi-layered attribution and incrementality model that is both innovative and resilient against noise, spillover, and false positives.

In some embodiments, the PHRCT MTA measurement described herein determines an incrementality measurement by comparing data associated with a key performance indicator (KPI) or conversion event from a particular advertiser (call it Brand X) to randomized sample of concurrent campaigns for other advertisers (call them Brands A, B, C, D, etc.). The data from the advertisers can be boosted with a shuffle sample from within a set of advertisements and normalized for impression scale and/or unique reach, in embodiments. Impression scale can refer to the total number of impressions (advertisement exposures) delivered by a campaign or associated with a tag. Normalizing for impression scale accounts for differences in the volume of impressions between the advertiser's campaign and the control campaigns, ensuring that campaigns with larger impression volumes are not unfairly weighted in the comparison. Unique reach can refer to the number of unique users or households exposed to an advertisement, where each user or household is counted only once regardless of the number of times they were exposed to the advertisement. Unique reach differs from impression scale in that impression scale counts total impressions (including multiple exposures to the same user), while unique reach counts only the distinct users or households reached. Normalizing for impression scale and unique reach ensures that the comparison between the advertiser's tags and the control tags accounts for differences in campaign size and audience reach. Incrementality measurement is produced by comparing the conversion rate of the advertiser for the KPI with the conversion rate of the randomized sample of other advertisers. The conversion rate of the randomized sample of other advertisers can be referred to as the control. The incrementality can be combined with a baseline attribution to determine an accurate multi-touch attribution measurement for a particular advertiser. The baseline attribution can represent the expected conversions if the advertisement has no effect. The incrementality measurement combined with the baseline can represent the total attributed events. In some embodiments, machine learning techniques can be used to fit the attribution to the observed incrementality for a particular marketing campaign and/or a particular content item of a marketing campaign.

In some embodiments, PHQED follows a similar logic of comparing the advertiser with a sample on other advertisements that run concurrently. However, rather than using randomized sampling of brands advertising concurrently, brands that more closely match the same ad size and targeting parameters are selected and then matched using statistical techniques such as entropy balancing, or iterative proportionate fit weighting, or a related technique. In some embodiments, PHQED may be used when the number of campaigns running concurrently is insufficient to provide a statistically reliable randomized sample, and instead matched control groups are selected based on similar ad size and/or targeting parameters.

A KPI can correspond to a conversion event, which is a specific action taken by a consumer that aligns with the goals of the advertisement campaign (or a promotional cycle). A conversion event can be digital in nature. Examples of a conversion event can be making a purchase (e.g., online), filing out a contact form, subscribing to a newsletter, downloading an application (e.g., on a smartphone), content engagement (e.g., watching a video, clicking a link, downloading a resource, such as an e-book), spending a certain amount of time on a webpage, completing a survey, signing up for a webinar, event, or a free trial, and so on. In some embodiments, digital conversion events can correspond to individual consumers or groups of consumers, determined using cookies, device identifier, IP addresses, etc. In some embodiments, a KPI or conversion event can have an associated pixel tracker, which can keep track of multiple advertisements that the user was exposed to prior to the conversion event. In some embodiments, consumers provide consent to tracking technologies (e.g., by opting in to cookies or privacy settings), and/or can opt-out of tracking technologies. In some embodiments, tracking data is anonymized to protect personal identities.

In some embodiments, a multi-touch attribution (MTA) component measures the attribution for a particular advertisement or promotional media content item. Attribution can refer to the opportunity of a promotional message (or set of promotional messages) to influence a conversion event. Attribution can show the touchpoints at which a consumer has been exposed to a promotional message(s) and subsequently converted. Incrementality can refer to the increase in a conversion rate attributable to the promotional message(s). Incrementality can represent the subset of the attributable conversions that were caused by the advertisement. Thus, the MTA component can measure the degree to which the advertiser's tag (or tracking identifier) is more associated with the KPI event as compared to a random sample of other tags.

In some embodiments, the MTA measurement can include a technique to correct for spillover effects by removing the “noise” caused by overlapping exposure. A spillover effect occurs when an event or action that occurs in one context causes unintended consequences in another context. That is, the impact of an advertisement (or the impact of exposure to a media content item) can extend beyond its intended audience or brand. To correct for spillover effects, the MTA measurement can include pairwise duplication that examines how exposure to placebo content items (e.g., the advertisements from Brands A, B, C, D, etc., used as a control) dilutes the true effect of the campaign. Spillover is accounted for by examining the pairwise duplication of the advertiser tag (representing ad exposure) with each tag of another advertiser (representing placebo ad exposure). A calculation backs out the dilution effect from spillover to recover the true effect after removing for spillover. Correcting for spillover effects enhances the accuracy of incrementality by isolating the true causal effect of the advertiser's campaign, thus avoiding over-attribution and strengthening causal claims.

In some embodiments, the MTA measurement can include a technique to account for lost signals. A lost signal can correspond to an exposure that can be, but is not, counted by the reach. Examples of such exposures include anonymous online actions (e.g., accessing the internet on a public computer without providing any identifier), opt-out tracking action, and/or cross-device signal loss where a user is exposed to an advertisement in one environment and converts in a different environment. These un-trackable interactions result in an impression count that cannot be linked back to a person due to their anonymity. To account for lost signals, the post hoc (after the fact) nature of the techniques described herein provide for a total incrementality that can be measured by measuring the difference between a metric value associated with the advertiser tags for the advertiser and a metric value associated with the advertiser tags for the control advertisements. The metric can be, for example, an index of conversions per reach. Lost signal events, such as anonymous or opt-out activity, are generally approximately the same in the control as in the advertiser groups. Thus, the MTA measurement can determine the overall incrementality, which is inclusive of the lost signal affect, and then distribute the incrementality across the number of attributed events for a particular conversion event. This differs from using traditional methods of attribution which flow forward rather than operating on a post hoc basis. The flow forward approach is based on recording impressions and then matching them to conversion events. Measuring lost signal is not possible with these flow forward techniques because an opt-out or anonymous signal is not included in the impression data set to connect with a future conversion event. In some embodiments, the MTA measurement can then determine a lost signal projection or scaling factor to apply to the attribution measurement to account for the lost signals.

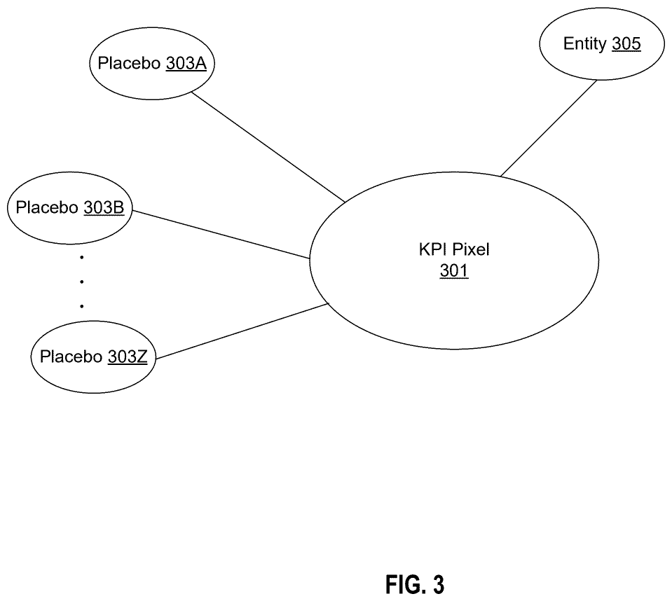

In some embodiments, the MTA measurement can include identifying a pixel associated with a KPI (e.g., a conversion event). A pixel can refer to a tracking pixel, which can be described as a small piece of code embedded on a website or digital advertisement to collect data about user activity and/or interactions. A pixel can track user interactions (e.g., clicks, purchases, form submissions), website visits and time spent on pages, email opens and interactions, user deice and location date, and so on. A pixel can send information (e.g., tracking data) to a server when triggered (e.g., when a user opens an email, makes a purchase, submits a form, accesses a website, etc.). In some embodiments, consumers provide consent to tracking technologies (e.g., by opting in to cookies or privacy settings), and/or can opt-out of tracking technologies. In some embodiments, tracking data is anonymized to protect personal identities. In some embodiments, a pixel can track which advertisements a user was exposed to prior to a conversion (or KPI) event. The advertisements that the user was exposed prior to the conversion event may include advertisements from a marketing campaign associated with the conversion event, as well as advertisements from marketing campaign(s) not associated with the conversion event. Each advertisement can be represented by a tag associated with the pixel. Thus, a pixel can be associated with multiple tags form multiple campaigns (e.g., as illustrated in FIG. 3).

In some embodiments, the MTA component can determine the reach of the advertisement corresponding to the tag(s) of the pixel. In some embodiments, the reach can correspond to a period of time (e.g., a seven-day lookback window). In some embodiments, the MTA component can normalize the tags of the pixel for their reach. In some embodiments, the MTA component can determine a baseline by multiplying the reach (or a rolling reach) by the total number of conversion events (e.g., during a period of time).

In some embodiments, the MTA component can train and/or implement an artificial intelligence (AI) model to provide the attribution by fitting to the measured incrementality. In some embodiments, the AI model may make a prediction of the incrementality, and the MTA component can estimate the attribution based on the incrementality. As more data is collected, the MTA component can fine-tune the AI model and/or adjust the attribution estimates. In some embodiments, the AI model can receive, as input, the tags associated with a particular KPI or conversion event and an identifier identifying the entity associated with the KPI or conversion event. The AI model can provide, as output, an incrementality measurement for the tag associated with the entity.

In some embodiments, the AI model can be trained using bootstrap methods, shuffle sampling, and/or random duplication techniques. In some embodiments, the MTA measurement can include performing random duplication of the tags associated with the pixel to confirm that the advertiser tag(s) is significantly higher, to the extent that there is incremental impact from the advertisements. The bootstrap method with shuffle sampling for signal robustness measures the degree to which the advertisers tag is more associated with the KPI compared to a random sample of other tags (e.g., tags not associated with the advertiser). These other tags (e.g., tags not associated with the advertiser) can be likened to placebo ads in a controlled experiment. Thus, the randomization and shuffle sampling of the other tags act as the control group in the PHRCT. In some embodiments, similar techniques are applied, however the control advertisements may be matched to the advertiser using weighting techniques such as entropy balancing, thus representing a quasi-experimental design (PHQED).

Using the incrementality output by the AI model, the MTA measurement can determine the total attributed events. The attributed events can be the incrementality added to the baseline. The MTA measurement can then adjust the attributed events for lost signal and/or spillover effect to determine a holistic and accurate attribution measurement.

In some embodiments, the MTA component can use the attribution measurement to determine return on advertisement spend (ROAS) and/or return on investment (ROI). In some embodiments, the MTA component can provide the incrementality, the attribution, the ROAS, and/or the ROI to a user device for presentation in a user interface (e.g., in a dashboard). In some embodiments, the MTA component can use the attribution measurement to identify characteristics of users (or groups of users) who performed a KPI or conversion event, which advertisements they were exposed to that led to the KPI or conversion event, and/or recommendations to increase ROAS and/or ROI, for example. The recommendations can include which advertisements to target to which user(s), at what time and through which channels, for example. The attribution measurement can be combined with other components to enable and support other features, such as using profiling, generating personas, etc.

Aspects of the present disclosure provide technical advantages over conventional forward-tracking attribution systems, including increased accuracy and reduced usage of computing resources used for analyzing and optimizing promotional cycles. That is, by accurately measuring multi-touch attribution, aspects of the present disclosure can result in more optimal use of financial resources directed toward advertising, and reduced computing resources (e.g., processing resources, bandwidth, memory usage, etc.) used in analyzing and optimizing advertising campaigns. For example, because the multi-touch attribution measurement described throughout is more accurate and holistic, the computing resources used in analyzing the effectiveness of a promotional cycle can be reduced using the techniques described throughout.

Aspects of the present disclosure provide technical advantages by addressing specific technical problems inherent in conventional attribution systems. Traditional attribution methods that track impressions forward to conversion events suffer from signal loss when users access the internet form multiple devices and connection types, resulting in incomplete and inaccurate data that requires repeated computation analysis to reconcile. The PHQED described herein solves this problem by reversing the computational approach, first by determining incrementality through shuffle sampling and bootstrap methods applied to concurrent campaign data, when by deriving attribution measures from the incrementality results. This approach reduces computational burden associated with attempting to deterministically or probabilistically match every impression to every conversion event across disparate devices and network connections. Additionally, by normalizing for measurement grain differences between person-level digital data and regional-level broadcast data, the system described herein reduces or eliminates the need for separate computational pipelines for different media types, thereby reducing processing overhead. The spillover correction and lost signal recovery techniques further improve computational efficiency by adjusting attribution measurements rather than requiring additional data collection and processing cycles to account for overlapping exposures and un-trackable interactions. As a result, the techniques described herein provide more accurate attribution measurements while reducing the processing resources, memory usage, and network bandwidth that would otherwise be consumed by conventional forward-tracking attribution systems attempting to achieve comparable accuracy.

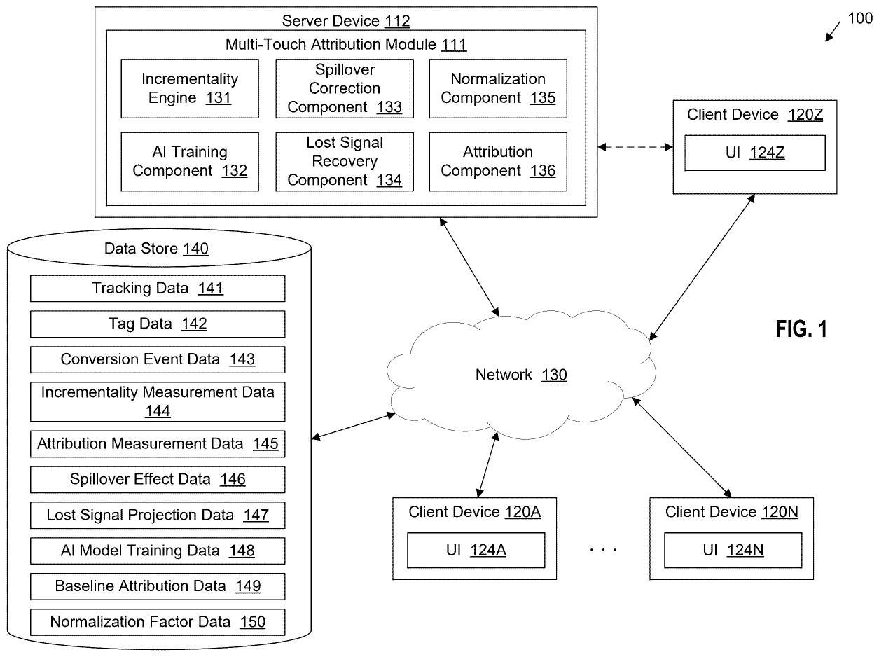

Referring now to the figures, FIG. 1 illustrates an example of a system architecture 100 for implementations of the present disclosure. The system architecture 100 includes a server device 112, a data store 140, and/or client devices 120A-Z connected via a network 130. The network 130 may be one or more public networks (e.g., the Internet), private networks (e.g., a local area network (LAN) or wide area network (WAN)), or a combination thereof. The network 130 may include a wireless infrastructure, which may be provided by one or more wireless communications systems, such as Wi-Fi hotspot connected with the network 130 and/or a wireless carrier system that can be implemented using various data processing equipment, communication towers, etc. Additionally or alternatively, the network 130 may include a wired infrastructure (e.g., Ethernet). In some embodiments, the network 130 can be a single network.

In some embodiments, data store 140 may be hosted by one or more storage devices, such as main memory, magnetic or optical storage based disks, tapes or hard drives, NAS, SAN, and so forth. In some implementations, data store 140 may be a network-attached file server, while in other embodiments data store 140 may be some other type of persistent storage such as an object-oriented database, a relational database, and so forth, that may be hosted by server device(s) 112, and/or client device(s) 120A-Z. In some embodiments, data store 140 may be hosted by or one or more different machines coupled to the server device 112, and/or user device 120A-Z.

In some embodiments, data store 140 can be a persistent storage that is capable of storing tracking data 141, tag data 142, conversion event data 143, incrementality measurement data 144, attribution measurement data 145, spillover effect data 146, lost signal projection data 147, AI model training data 148, baseline attribution data 149, and/or normalization factor data 150.

In some embodiments, the tracking data 141 can include data received from tracking pixels associated with KPIs or conversion events. The tracking data 141 can include a timestamp, an IP address, a device type, a browser type, a referrer URL, and/or other user interactions associated with a triggering event (e.g., loading a website, opening an email, making a purchase, etc.). In some embodiments, the tracking data 141 can be anonymized to protect personal identities. In some embodiments, the tracking data 141 can include consent indicators representing whether a user has opted in or opted out of tracking technologies.

In some embodiments, the tag data 142 can include tracking identifiers representing advertisements that users were exposed to prior to conversion events. The tag data 142 can include advertiser tags corresponding to advertisements from a marketing campaign associated with a conversion event, as well as placebo tags corresponding to advertisements from concurrent campaigns not associated with the conversion event. In some embodiments, the tag data 142 can be associated with a pixel, such that a single pixel can be associated with multiple tags from multiple campaigns. The tag data 142 can be used by the multi-touch attribution module 111 to compare advertiser tags against placebo tags in the post-hoc quasi-experimental design.

In some embodiments, the conversion event data 143 can include records of specific actions taken by consumers that align with the goals of an advertisement campaign or promotional cycle. The conversion event data 143 can include digital conversion events such as purchases (e.g., online purchases), form submissions (e.g., contact forms), newsletter subscriptions, application downloads (e.g., on a smartphone), content engagement events (e.g., watching a video, clicking a link, downloading a resource such as an e-book), time spent on a webpage, survey completions, and/or sign-ups for webinars, events, or free trials. In some embodiments, the conversion event data 143 can correspond to individual consumers or groups of consumers, determined using cookies, device identifiers, IP addresses, and/or household identifiers.

In some embodiments, the incrementality measurement data 144 can include calculated incrementality counts and incremental lift values determined by the multi-touch attribution module 111. The incrementality measurement data 144 can include the results of comparing advertiser conversion rates against control group conversion rates using post-hoc randomized controlled test (PHRCT) or post-hoc quasi-experimental design (PHQED) methods. In some embodiments, the incrementality measurement data 144 can represent the subset of attributable conversions that were caused by the advertisement, as determined by bootstrap methods, shuffle sampling, and/or random duplication techniques.

In some embodiments, the attribution measurement data 145 can include multi-touch attribution values derived from the incrementality measurement data 144 after applying spillover corrections and lost signal adjustments. The attribution measurement data 145 can represent the total attributed events, which can be calculated as the incrementality count added to a baseline attribution value. In some embodiments, the attribution measurement data 145 can include return on advertisement spend (ROAS) and/or return on investment (ROI) values calculated from the attribution measurements.

In some embodiments, the spillover effect data 146 can include pairwise duplication calculations representing the overlap between advertiser tags and placebo tags. The spillover effect data 146 can include the number of impressions or users exposed to both the advertiser tag and each placebo tag, as well as corresponding spillover bias adjustments. In some embodiments, the spillover effect data 146 can include spillover-adjusted placebo exposure values and spillover-corrected incremental lift values calculated by the multi-touch attribution module 111.

In some embodiments, the lost signal projection data 147 can include scaling factors and projection values used to account for untrackable interactions. The lost signal projection data 147 can include measurements corresponding to anonymous online actions (e.g., accessing the internet on a public computer without providing any identifier), opt-out tracking actions, and/or cross-device signal loss. In some embodiments, the lost signal projection data 147 can include the difference between the incrementality count determined by the multi-touch attribution module 111 and a traditional incrementality count determined using conventional forward-tracking methods.

In some embodiments, the AI model training data 148 can include training datasets comprising sets of training inputs and target outputs used to train and fine-tune AI models for incrementality prediction. The AI model training data 148 can include tags associated with conversion events, entity identifiers, and corresponding incrementality measurements. In some embodiments, the AI model training data 148 can include data gathered during a first time period of a planned advertisement campaign (e.g., during the first portion of the campaign) that is used to train or fine-tune a campaign-specific AI model.

In some embodiments, the baseline attribution data 149 can include calculated baseline values representing expected conversions in the absence of advertising impact. The baseline attribution data 149 can be calculated by multiplying the reach (or a rolling reach) of an advertisement by the total number of conversion events during a period of time. Reach can refer to the number of unique users or households that were exposed to an advertisement at least once during a particular time period. Rolling reach refers to a reach calculation that is continuously updated over a moving time window, such that the reach value at any given point reflects the cumulative number of unique users or households exposed to the advertisement during the preceding lookback period (e.g., a seven-day lookback window). In some embodiments, the baseline attribution data 149 can correspond to a lookback window (e.g., a seven-day lookback window). In some embodiments, the incrementality engine 131 can determine the reach of an advertisement by counting the number of unique users or households exposed to the advertisement during the lookback window. The reach can be determined by analyzing the tracking data 141 to identify unique user identifiers, household identifiers, device identifiers, or IP addresses associated with impressions of the advertisement. When a user is exposed to the same advertisement multiple times, the incrementality engine 131 can deduplicate the exposures to count the user only once toward the reach calculation. In some embodiments, the reach can be determined using the identity graph to associate multiple device identifiers or IP addresses with a common household identifier, thereby providing a household-level reach measurement.

In some embodiments, the normalization factor data 150 can include empirically derived values used to normalize for measurement grain differences between person-level digital data and regional-level broadcast data. As used herein, “measurement grain” can refer to the level of granularity at which advertising impression and conversion data is collected and analyzed. Person-level grain (or household-level grain) can refer to data collected at the individual user or household level, where each impression and conversion can be associated with a specific identifier. Regional-level grain can refer to data aggregated at a geographic region level (such as a Designated Market Area or DMA), where impressions and conversions are aggregated across all users within the region. Different media types may use different measurement grains. For example, digital advertising typically uses person-level grain, while broadcast advertising typically uses regional-level grain. The normalization factor data 150 can account for the systematic differences in attribution signal that occur when comparing data collected at different measurement grains. The normalization factor data 150 can include frequency normalization values used to compare different advertisement placements at different frequency levels, as well as privacy consent projection factors calculated based on the percentage of users who opted in or opted out of tracking. In some embodiments, the normalization factor data 150 can be derived from empirical analysis of digital campaigns analyzed using different measurement grains (e.g., person grain versus designated market area (DMA) grain) to produce normalization factors applied to media whose impressions are reported at the regional level.

The client devices 120A-Z may represent one or more physical machines (e.g., server machines, desktop computers, mobile devices, etc.) that include one or more processing devices communicatively coupled to memory devices and input/output (I/O) devices. In some embodiments, a client device 120A-Z can be used to perform a conversion event. In some embodiments, a client device 120A-Z can be used to provide a promotional item. In some embodiments, a client device 120A-Z can be used to implement a promotional cycle. In some embodiments, a client device 120A-Z can be used to display the results of a promotional cycle (e.g., as determined by MTA module 111). In some embodiments, the client devices 120A-Z can include user interfaces 124A-Z configured to display attribution measurements and incrementality counts to users. For instance, user interface 124A may display a dashboard displaying attribution measurement data 145, incrementality measurement data 144, return on advertisement spend (ROAS), and/or return on investment (ROI) values. As another example, user interfaces 124B-Z may include visualization components such as charts, graphs, and/or tables presenting spillover effect data 146, lost signal projection data 147, and/or baseline attribution data 149. In some embodiments, user interfaces 124A-Z may include interactive elements enabling users to view conversion event data 143 by segment, compare performance across different advertisement placements, and/or receive recommendations for optimizing promotional cycles based on the multi-touch attribution analysis.

The server device 112 may represent one or more physical machines (e.g., server machines, desktop computers, etc.) that include one or more processing devices communicatively coupled to memory devices and input/output (I/O) devices. In some embodiments, server device 112 can include a multi-touch attribution (MTA) module 111. In some embodiments, MTA module 111 can include software, hardware, and/or firmware configured to perform one or more operations with respect to determine multi-touch attribution measurements. The multi-touch attribution module 111 can include an incrementality engine 131, an AI training component 132, a spillover correction component 133, a lost signal recovery component 134, a normalization component 135, and/or an attribution component 136. The functions of the components 131-136 can be combined into fewer components, and/or separated into additional components.

In some embodiments, the incrementality engine 131 can determine incrementality measurements for advertising campaigns using a post-hoc randomized controlled test (PHRCT) and/or a post-hoc quasi-experimental design (PHQED). Unlike traditional randomized controlled experiments that require partitioning the population into two groups and using a placebo advertisement as a baseline control group (which is expensive because the advertiser pays for impressions for the control group), the PHRCT and PHQED approaches use existing concurrent campaigns as the control. The incrementality engine 131 can compare data associated with a KPI or conversion event from a particular advertiser (e.g., Brand X) to a randomized sample of concurrent campaigns for other advertisers (e.g., Brands A, B, C, D, etc.). The tags for the other advertisers can serve as placebo tags, similar to placebo advertisements in a controlled experiment.

In some embodiments, the incrementality engine 131 can identify a pixel associated with a KPI (e.g., a conversion event). The pixel can be a tracking pixel, which can be described as a small piece of code embedded on a website or digital advertisement to collect data about user activity and/or interactions. The pixel can track user interactions (e.g., clicks, purchases, form submissions), website visits and time spent on pages, email opens and interactions, and/or user device and location data. The pixel can send tracking data 141 to server device 112 when triggered (e.g., when a user opens an email, makes a purchase, submits a form, accesses a website, etc.), in embodiments. In some embodiments, server device 112 can access tracking data 141. The pixel can track which advertisements a user was exposed to prior to a conversion event. The advertisements that the user was exposed to prior to the conversion event may include advertisements from a marketing campaign associated with the conversion event, as well as advertisements from marketing campaign(s) not associated with the conversion event. Each advertisement can be represented by a tag associated with the pixel. Thus, a pixel can be associated with multiple tags from multiple campaigns, as illustrated in FIG. 3.

In some embodiments, the incrementality engine 131 can determine the reach of the advertisement corresponding to the tag(s) of the pixel. The reach can be described as the number of people (or households) during a particular time period that statistically would have been exposed to the advertisement at least once. In some embodiments, the reach can correspond to a rolling reach calculated over a period of time (e.g., a seven-day lookback window), representing the cumulative number of unique users or households exposed to the advertisement during that period.

In some embodiments, the incrementality engine 131 can normalize the tags of the pixel for their reach. The normalization for reach can account for differences in impression scale and/or unique reach between the advertiser's tags and the placebo tags, ensuring that the comparison of conversion rates in the post-hoc quasi-experimental design is not biased by differences in campaign size or audience reach. By normalizing the tags for their reach, the incrementality engine 131 can accurately measure the degree to which the advertiser's tag is more associated with the KPI compared to the control tags, regardless of whether the advertiser's campaign delivered more or fewer impressions than the concurrent campaigns used as controls.

In some embodiments, the incrementality engine 131 can determine a baseline by multiplying the reach (or a rolling reach) by the total number of conversion events (e.g., during a period of time). The baseline can represent the expected conversions if the advertisement has no effect at all. That is, the baseline can represent conversions that would be attributed to the advertiser based solely on the overlap between the campaign's reach and the overall conversion activity in the population, without any incremental impact from the advertising. The baseline can serve as the reference point against which incrementality is measured. If the measured incrementality is higher than the baseline number, the difference represents the incremental conversions caused by the advertising. The incrementality count added to the baseline represents the total attributed events. By determining both the baseline and the incrementality count, the incrementality engine 131 can provide the attribution component 136 with the data needed to calculate the final attribution measurement. The baseline attribution data 149 can be stored in data store 140.

In some embodiments, the incrementality engine 131 can boost the data from the advertisers with a shuffle sample from within the advertisements and normalize for impression scale and unique reach. Shuffle sampling can refer to a statistical resampling technique in which the tags are randomly reordered and sampled to create randomized control groups for comparison against the advertiser's tags. In shuffle sampling, the tags associated with concurrent campaigns (the placebo tags) are randomly shuffled and sampled to generate a control group, and this process can be repeated multiple times to create multiple randomized control groups. By comparing the advertiser's tag performance against multiple shuffled samples of control tags, the incrementality engine 131 can develop a statistically robust measure of the true incremental impact of the advertiser's campaign. Boosting the data can increase the statistical power of the post-hoc quasi-experimental design by amplifying the signal of the advertiser's incremental impact relative to the noise inherent in the control group measurements, thereby enabling the incrementality engine 131 to detect smaller incremental effects that might otherwise be obscured by random variation in the data. The boosting of data can involve applying bootstrap methods to the plurality of tags, wherein the tags are randomly sampled and duplicated to create multiple randomized control groups for comparison against the advertiser's tags. This bootstrap method with shuffle sampling can be repeated multiple times (e.g., 30 iterations) to generate a distribution of control group measurements, enabling the incrementality engine 131 to develop a statistically robust measure of the true incremental impact of the advertiser's campaign and to establish confidence intervals for the incrementality measurement.

In some embodiments, the incrementality measurement can be produced by comparing the conversion rate of the advertiser for the KPI with the conversion rate of the randomized sample of other advertisers. The conversion rate of the randomized sample of other advertisers can be referred to as the control. The incrementality engine 131 can use bootstrap methods with shuffle sampling for signal robustness to measure the degree to which the advertiser's tag is more associated with the KPI compared to a random sample of other tags (e.g., tags not associated with the advertiser). The bootstrap method with shuffle sampling can perform random duplication of the tags associated with the pixel to confirm that the advertiser tag(s) is significantly higher, to the extent that there is incremental impact from the advertisements. The randomization and shuffle sampling of the other tags act as the control group in the PHRCT.

In some embodiments, the incrementality engine 131 can use PHQED when the number of campaigns running concurrently is insufficient to provide a statistically reliable randomized sample. In PHQED, rather than using randomized sampling of brands advertising concurrently, brands that more closely match the same ad size and targeting parameters are selected and then matched using statistical techniques such as entropy balancing, iterative proportionate fit weighting, or a related technique. The matched control groups can be selected based on similar ad size and targeting parameters to achieve statistical reliability with fewer concurrent campaigns. In some embodiments, the PHRCT and/or PHQED can act as a secondary check on the AI incrementality results, ensuring statistical significance. That is, the PHRCT and/or PHQED confirms that an advertiser's advertising events outperform placebo advertisements, providing rigorous evidence of campaign impact.

In some embodiments, the incrementality engine 131 can determine incrementality measurements using a control household matching process. The control household matching process can select and pair control households with exposed households based on matching variables to create matched control groups for quasi-experimental incrementality analysis.

In some embodiments, a pool of potential control households can be identified from a population of households that were not exposed to the advertising campaign being measured. From this pool, control households can be selected and paired with exposed households based on a plurality of matching variables. The matching variables can include pre-period conversions, digital activity levels, ad exposure history, geography, active status, demographics, offline behaviors, and/or population density. A control household can be selected and paired with an exposed household if the two households are identical or substantially similar across all matching variables.

In some embodiments, the control household matching process can be repeated multiple times to generate randomly selected control groups for each exposed household. For example, the matching process can be repeated 30 times, meaning 30 randomly selected control groups can be generated for each exposed household. Each iteration of the matching process can select a different set of control households (e.g., a first control household 1, a second control household 2, a third control household 3, a fourth control household 4, a fifth control household 5, etc.) that match the characteristics of the exposed household across the matching variables.

In some embodiments, the matching variables can be visualized as a multi-dimensional profile for each household. The profile can represent the household's characteristics across each of the matching dimensions, such as pre-period conversions, digital activity levels, ad exposure, geography, active status, demographics, offline behaviors, and/or population density. A control household can be considered a match for an exposed household when the profiles of the two households are identical or substantially similar across all dimensions.

In some embodiments, the control household matching process can be used when implementing the PHQED. As described herein, PHQED can be used when the number of campaigns running concurrently is insufficient to provide a statistically reliable randomized sample. Rather than using randomized sampling of brands advertising concurrently, the PHQED approach selects control groups that more closely match the characteristics of the exposed group using statistical techniques such as entropy balancing or iterative proportionate fit weighting. The control household matching process ensures that exposed and unexposed households share similar characteristics across multiple demographic, behavioral, and geographic dimensions, thereby reducing bias in the measurement of advertising effectiveness.

In some embodiments, the incrementality engine 131 can compare the conversion rates of the exposed households against the conversion rates of the matched control households to determine the incrementality count. Because the control households are matched to the exposed households across the plurality of matching variables, any difference in conversion rates between the two groups can be attributed to the effect of the advertising exposure rather than to differences in household characteristics. This matching methodology enables accurate incrementality measurement by controlling for confounding variables that could otherwise bias the results.

In some embodiments, the multiple iterations of the matching process (e.g., 30 iterations) can be used to develop a highly reliable measure of the true incremental impact of advertising. By generating multiple matched control groups and comparing the results across iterations, the incrementality engine 131 can use bootstrap methods to establish confidence intervals and ensure statistical significance of the incrementality measurements.

In some embodiments, data store 140 can maintain an identity graph that associates multiple user identifiers, device identifiers, and/or IP addresses with a common household entity based on verified data points. In some embodiments, the incrementality engine 131 can use the identity graph for deterministic matching to establish household-level attribution. The identity graph can enable accurate attribution of advertising exposures and conversion events across multiple devices within the same household.

In some embodiments, the identity graph can link advertising impressions delivered to a first device (e.g., a desktop computer, a tablet, a smart television) to conversion events that occur on a second device (e.g., a smartphone, a laptop) within the same household. For example, a user may view an advertisement on a home computer connected to a residential IP address and subsequently make a purchase on a mobile device. The identity graph can associate both the home computer and the mobile device with a common household identifier (e.g., Household ID), enabling the multi-touch attribution module 111 to attribute the conversion event to the advertising impression even though the impression and conversion occurred on different devices.

In some embodiments, the identity graph can provide deterministic matching for users accessing the internet from home, where the household IP address and logged-in user identifiers provide consistent signals for matching impressions to conversions. Deterministic matching can refer to matching based on verified, known identifiers (such as email addresses, login credentials, or device identifiers) rather than probabilistic inference. The identity graph can maintain associations between household identifiers, device identifiers, IP addresses, and user identifiers to enable deterministic matching across the household.

In some embodiments, the tracking data 141 can include household identifiers determined using the identity graph. When a tracking pixel associated with a KPI receives a triggering event (e.g., a conversion event), the incrementality engine 131 can use the identity graph to identify the household associated with the conversion event based on the IP address, device identifier, and/or user identifier included in the tracking data 141. The incrementality engine 131 can then identify advertising impressions (represented by tags in the tag data 142) that were delivered to any device within the same household during the lookback window.

In some embodiments, the identity graph can be limited to a particular geographic region. For example, the identity graph can provide deterministic matching for impressions and conversions occurring within the United States, where household-level data is available. Any impressions or conversions delivered outside of the geographic region covered by the identity graph may not match the identity graph, and the incrementality engine 131 can partition traffic by country of origin to ensure that attribution analysis is performed using appropriate matching techniques for each region.

In some embodiments, the lost signal recovery component 134 can account for situations where the identity graph cannot establish a deterministic match. For example, when a user accesses the internet away from home (e.g., using a cellular connection, a public Wi-Fi network, or a work network), the connection may look different from the at-home connection (e.g., different IP address), and the identity graph may not be able to link the away-from-home impression to the household. These unmatched impressions can contribute to lost signals, which the lost signal recovery component 134 can account for using the projection factors described herein.

In some embodiments, lost signals can occur when the identity graph cannot establish a deterministic match between an advertising impression and a conversion event. As an illustrative example, a user may listen to a podcast advertisement on their smartphone while commuting (using a cellular connection), and later make a purchase on their home computer (using a residential IP address). The identity graph may be able to identify the household associated with the home computer based on the residential IP address, but may not be able to link the podcast impression delivered via the cellular connection to the same household. In this scenario, the podcast impression would be a lost signal because it cannot be deterministically matched to the conversion event. The lost signal recovery component 134 can account for these unmatched impressions by measuring the overall incrementality using the post-hoc comparative analysis (which is inclusive of the lost signal effect) and distributing the incrementality across the attributed events.

In some embodiments, the incrementality engine 131 can use a trained AI model to determine the incrementality count corresponding to the advertiser's tag. In some embodiments, the AI training component 132 can generate training data and/or train or fine-tune AI models used to predict incrementality counts based on tags and entity identifiers. In some embodiments, the AI training component 132 can generate training data that includes tags associated with conversion events, entity identifiers, and corresponding incrementality measurements determined by the incrementality engine 131. The training data can be stored in AI model training data 148 of data store 140. In some embodiments, the AI model can receive, as input, the tags associated with a particular KPI or conversion event and an identifier identifying the entity associated with the KPI or conversion event. The AI model can provide, as output, an incrementality measurement for the tag associated with the entity.

In some embodiments, the AI training component 132 can train the AI model using bootstrap methods, shuffle sampling, and/or random duplication techniques. The AI model can be or include a linear regression model, a neural network, a decision tree, a support vector machine, a gradient boosting model, and/or other suitable model architectures configured to fit the input features to the incrementality data and determine a best fit prediction of incrementality counts. The shuffle sampling of different tag combinations can develop a highly reliable measure of the true incremental impact of advertising.

In some embodiments, the AI training component 132 can gather data during a first time period of a planned advertisement campaign (e.g., during the first week of the campaign) and use the data to train or fine-tune a campaign-specific AI model. As an illustrative example, it can take approximately four days of computation to process patterns of exposure and conversion for a campaign, feeding on the first week of campaign data, after which an incrementality model becomes available. After this period, the AI training component 132 can run the campaign-specific AI model for the rest of the duration of the campaign. As more data is collected throughout the campaign, the AI training component 132 can continue to fine-tune the AI model and adjust the attribution estimates accordingly.

In some embodiments, the AI training component 132 can leverage historical campaign data to establish benchmark learning that serves as prior knowledge for new campaigns. The AI training component 132 can perform computationally intensive benchmark analysis after completion of a campaign (or after a certain period of time has elapsed), analyzing patterns of exposure and conversion across multiple campaigns to develop normative models. The benchmark learning can then be used as priors in a Bayesian model for subsequent campaigns, enabling faster calculation and delivery of results in near real-time. Attribution can be available nearly instantaneously, and thus attribution can be used as a leading indicator for incrementality while the more computationally intensive incrementality analysis is being performed.

In some embodiments, the AI training component 132 can train the AI model to empirically measure the differential contribution of each advertising touch to a conversion event. This differs from ascription approaches that simply assign equal weights to all touches or apply a time-based decay to the influence of multiple touches. Some make the mistake of equally weighting touches or using a time-based decay, but these approaches do not measure the contribution of each touch. Rather, these approaches impose a fixed weighting scheme that can significantly distort the true contribution of each touch. For example, a person may be exposed to both a pre-roll video ad and subsequently, a few hours to a day later, a micro bar (88×31 pixels) ad in a cluttered affiliate marketing page. The video ad may have significantly more incremental influence on purchase than the micro bar ad, yet conventional measurements may weight the micro bar higher purely because it was more recently viewed compared to the video. The AI training component 132 can train AI model to recognize these differential contributions using the incrementality measurements from the post-hoc quasi-experimental design as ground truth. For example, the AI training component 132 can receive the attributed data with rich detail, including every advertisement the user was exposed to along with timestamps, ad types, and/or placement context, and can use the overall incrementality measurement as the target output for training. The AI model can learn to distribute the overall incrementality across the individual advertising touches based on their characteristics, thereby determining how each touch contributed to the incremental outcome, in embodiments.

In some embodiments, the spillover correction component 133 can account for spillover effects that occur when exposure to advertisements extends beyond intended audiences. A spillover effect occurs when an event or action that occurs in one context causes unintended consequences in another. That is, the impact of an advertisement (or the impact of exposure to a media content item) can extend beyond its intended audience or brand. The spillover effect can reduce the appearance of incrementality because it dilutes the measured effect. Some people who appear to be in the control group (exposed only to placebo advertisements) may have also been exposed to the advertiser's advertisement, making their probability of conversion higher than a true control group.

In some embodiments, the spillover correction component 133 can perform pairwise duplication analysis that examines how exposure to placebo content items (e.g., the advertisements from Brands A, B, C, D, etc., used as a control) dilutes the true effect of the campaign. Spillover is accounted for by examining the pairwise duplication of the advertiser tag (representing ad exposure) with each tag of another advertiser (representing placebo ad exposure). For example, the pairwise duplication of the advertiser tag (e.g., entity tag 305 of FIG. 3) with each placebo tag (e.g., placebo tags 303A-Z of FIG. 3) can be examined to account for spillover effects. The spillover correction component 133 can determine how many “collisions” there are between the campaign being measured and the random sample of other advertisements. The spillover correction component 133 can calculate the dilution effect from spillover to recover the true effect after removing for spillover. The spillover effect data 146 can be stored in data store 140.

In some embodiments, the spillover correction component 133 can determine the spillover-adjusted placebo exposure by subtracting the total impressions (or users) exposed to both the advertiser tag and the placebo tag from the total impressions (or users) exposed to the placebo tag. This adjusts the placebo group size downward, removing the portion of overlap with the advertiser's audience. The spillover correction component 133 can calculate the spillover-corrected incremental lift by subtracting the spillover bias from the incremental lift measured before spillover adjustment. The spillover bias can be calculated as the ratio of the pairwise duplication to the total placebo exposure, multiplied by the measured placebo lift before adjustment. When tracking across multiple placebo tags, the spillover correction component 133 can sum the contributions of each placebo tag to determine the total spillover bias, and can adjust the advertiser lift by subtracting the cumulative spillover bias. Correcting for spillover effects enhances the accuracy of incrementality by isolating the true causal effect of the advertiser's campaign, thus avoiding over-attribution and strengthening causal claims.

In some embodiments, the lost signal recovery component 134 can recover signals that are lost due to anonymous online actions or opt-out tracking actions. A lost signal can correspond to an exposure that can be, but is not, counted by the reach. Examples of lost signals can correspond to anonymous online actions (e.g., accessing the internet on a public computer without providing any identifier), opt-out tracking actions (e.g., clicking “Ask App not to Track” upon installing or launching an application), and/or cross-device signal loss. These untrackable interactions result in an impression count that cannot be linked back to a person due to their anonymity.

In some embodiments, lost signals can be caused by a combination of the flow forward nature of traditional attribution and the nature of users using various devices and various methods to connect to the Internet, such as cable connections at home, cellular away from home, public Wi-Fi connections, and so on. As an illustrative example, a user may see an impression in one environment (e.g., on their cell phone using a public Wi-Fi connection) and convert in a different environment (e.g., on their home computer using a cable connection), thus looking as if the conversion was not caused by the impression. In this example, the impression the user first saw on their cell phone may not be attributed to the conversion. The impression is a lost signal.

In some embodiments, the lost signal recovery component 134 can account for lost signals using the post-hoc nature of the techniques described herein. The total incrementality can be measured by measuring the difference between a metric value associated with the advertiser tags for the advertiser and a metric value associated with the advertiser tags for the control advertisements. The metric can be, for example, an index of conversions per reach. Lost signal events, such as anonymous or opt-out activity, are generally approximately the same in the control as in the advertiser groups. Thus, the lost signal recovery component 134 can determine the overall incrementality, which is inclusive of the lost signal effect, and then distribute the incrementality across the number of attributed events for a particular conversion event.

In some embodiments, the lost signal recovery component 134 can determine a lost signal projection or scaling factor to apply to the attribution measurement to account for the lost signals. The lost signal recovery component 134 can determine the lost signal measurement by determining a traditional incrementality count using conventional forward-tracking methods and determining a difference between the incrementality count from the post-hoc quasi-experimental design and the traditional incrementality count. The difference represents the lost signal measurement. The lost signal projection data 147 can be stored in data store 140.

In some embodiments, the normalization component 135 can normalize data to account for differences in measurement grain across different media types. Cross-channel multi-touch attribution involves comparing two or more media that are distinct in their measurement approaches and combining them into a multi-touch attribution and incrementality analysis. For example, podcast and broadcast are distinct measurements because podcast uses a digital person (or household) level analysis of impressions while broadcast uses regional level impressions (e.g., DMA). Digital advertising data is at the device level, and generally aggregated to the person or household as the unit of impression and conversion measurement. Broadcast, on the other hand, uses a regional grain of impression analysis because it is not generally possible to observe impression delivery at the device, person, or household level.

In some embodiments, when two media use a different grain of measurement, such as digital using the person grain and broadcast using the DMA grain, the data must be normalized to account for differences in measurement grain, otherwise the method will produce biased output. Empirical analysis shows a systematic loss of attribution signal when aggregating data from person grain to DMA (or other regional level), and this empirical analysis is used for normalization. The normalization component 135 can analyze the same digital campaigns using different grains to produce the normalization factor applied to media whose impressions are reported at the regional level. A standard regression of DMA to household level attribution and incrementality normalizes the results so that one can make side-by-side comparisons of conversions, cost per conversion, and marginal conversions. This enables comparison of different media types (e.g., podcast to broadcast) on a like-for-like basis. The normalization factor data 150 can be stored in data store 140.

In some embodiments, the normalization component 135 can apply frequency normalization when comparing different advertisement placements that have different frequency levels. Since advertising impact has a diminishing returns signature by frequency, comparing two placements to determine which is more impactful should be done using the normalized frequency (such as relative impact at a frequency of 1.0). In some embodiments, the normalization component 135 can apply spend normalization, which is useful when determining the cost per action and optimizing after cost per thousand impressions (CPMs) have been set.

In some embodiments, the normalization component 135 can apply privacy consent normalization to account for signal loss due to opt-in/opt-out and/or related privacy laws. The normalization component 135 can count total impressions and calculate the percent of time the macro expands, as well as aggregated data features of those that consented versus those that did not, to produce a projection factor that minimizes bias. This can be referred to as “normalizing for signal loss.” Of the normalizations, data aggregation and privacy can be required for accurate attribution.

In some embodiments, the normalization component 135 can apply spend normalization when determining cost per action and optimizing advertising budget allocation after cost per thousand impressions (CPM) rates have been set. Spend normalization can account for differences in media costs across different advertisement placements, channels, and/or media types to enable accurate comparison of advertising efficiency.

In some embodiments, the normalization component 135 can normalize attribution and incrementality measurements by the cost of each advertisement placement to determine cost per action (CPA) values. The cost per action can be calculated by dividing the cost of each line of media by the attributed and incremental conversions based on the multi-touch attribution analysis. Spend normalization enables advertisers to compare the efficiency of different placements that may have different CPM rates, impression volumes, and/or conversion rates.

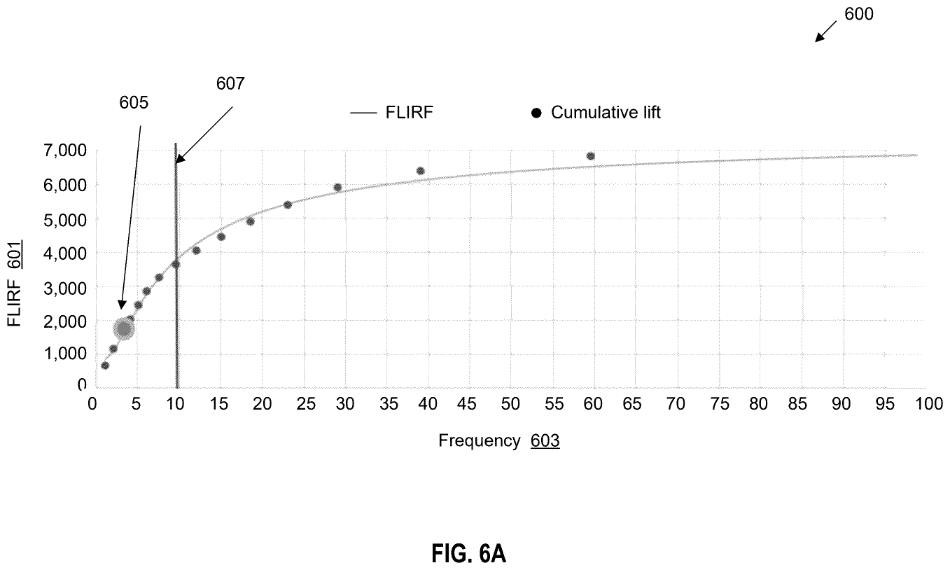

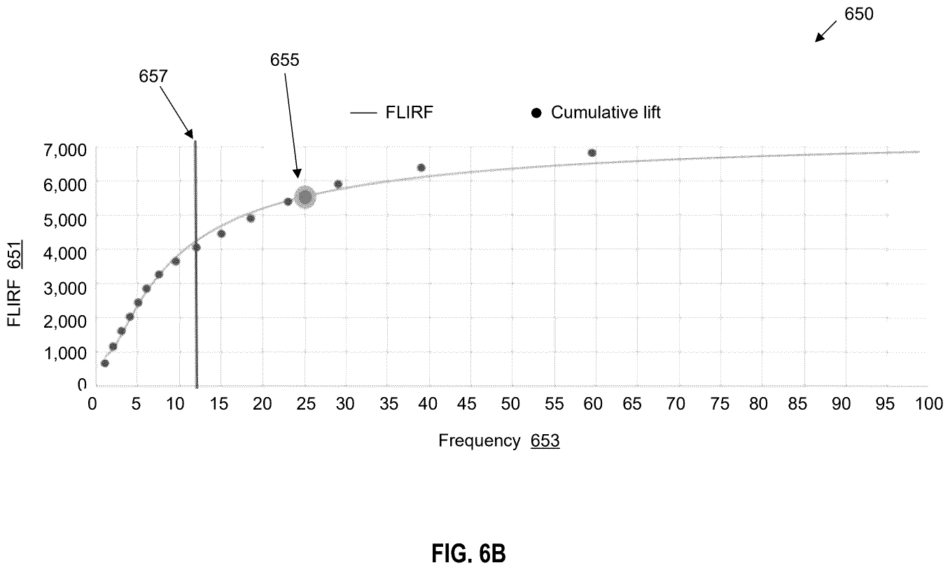

In some embodiments, the normalization component 135 can apply spend normalization in conjunction with the marginal cost per action analysis. The marginal cost per action can be calculated by dividing the marginal conversions (e.g., determined from the frequency to lift response function as described with respect to FIGS. 6A and 6B) by the cost of the additional frequency. Since the cost per thousand impressions (CPM) can vary across placements and can be negotiated, the normalization component 135 can normalize the marginal returns by the CPM to determine the marginal cost per action for each placement. This spend-normalized marginal cost per action enables advertisers to identify which placements offer the highest marginal returns per dollar invested.

In some embodiments, the normalization component 135 can support what-if analysis by enabling advertisers to adjust CPM values and observe the impact on spend-normalized metrics. Since CPM rates can change over time due to market conditions, negotiations, and/or changes in advertising strategy, advertisers may need to consider how changes in CPM affect the relative efficiency of different placements. The normalization component 135 can recalculate spend-normalized cost per action and marginal cost per action values based on adjusted CPM inputs, enabling advertisers to determine the optimal budget allocation under different cost scenarios.

In some embodiments, the spend normalization performed by the normalization component 135 can be combined with the frequency normalization and/or measurement grain normalization to provide a comprehensive normalized view of advertising performance. By normalizing for spend, frequency, and/or measurement grain, the multi-touch attribution module 111 can enable like-for-like comparison of different advertisement placements across different media channels (e.g., digital, broadcast, podcast) operating at different frequency levels and different cost structures. The normalized attribution and incrementality measurements can be stored in normalization factor data 150 of data store 140 and/or provided to a user device (e.g., client device 120A-Z) for presentation in a user interface (e.g., in a dashboard displayed via user interface 124A-Z), in embodiments.

In some embodiments, the attribution component 136 can determine attribution measurements based on the incrementality counts and adjustments for spillover effects and/or lost signals. Attribution can refer to the opportunity of a promotional message (or set of promotional messages) to influence a conversion event. Attribution can show the touchpoints at which a consumer has been exposed to a promotional message(s) and subsequently converted. Incrementality can refer to the increase in a conversion rate attributable to the promotional message(s). Incrementality can represent the subset of the attributable conversions that were caused by the advertisement. Thus, the attribution component 136 can measure the degree to which the advertiser's tag (or tracking identifier) is more associated with the KPI event as compared to a random sample of other tags.

In some embodiments, the attribution component 136 can combine the incrementality measurement with a baseline attribution to determine an accurate multi-touch attribution measurement for a particular advertiser. The baseline attribution can be calculated by multiplying the reach (or a rolling reach) of an advertisement by the total number of conversion events during a period of time (e.g., a lookback window). If the incrementality has been measured, it should be higher than the baseline number, indicating that the advertising had a positive effect on conversions. The incrementality measurement combined with the baseline can represent the total attributed events. The attribution component 136 can determine the total attributed events by adding the incrementality count to the baseline attribution. For example, if the baseline attribution is 1,000 conversions (based on reach multiplied by the background conversion rate) and the incrementality count is 500 conversions (representing the additional conversions caused by the advertising), the total attributed events would be 1,500 conversions. The attribution component 136 can then adjust the total attributed events by adding back the spillover effect (which had reduced the appearance of incrementality due to audience overlap with control campaigns) and/or scaling by the lost signal projection factor (to account for untrackable interactions). The attribution measurement data 145 can be stored in data store 140.

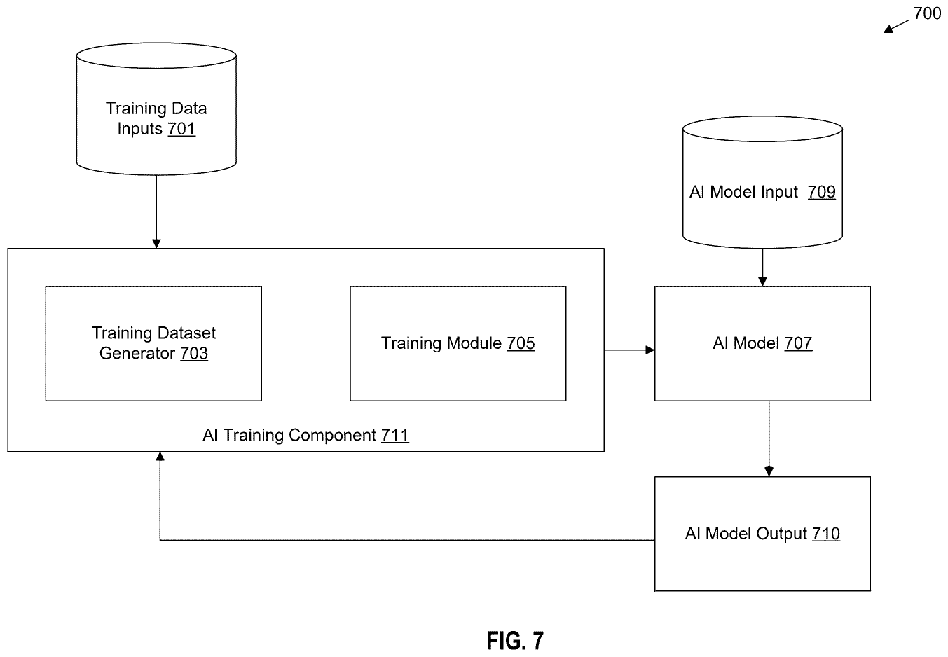

In some embodiments, the attribution component 136 can use machine learning techniques to fit the attribution to the observed incrementality for a particular marketing campaign and/or a particular content item of a marketing campaign. The attribution component 136 can receive the overall incrementality measurement from the incrementality engine 131 and the detailed attributed data that includes every advertisement the user was exposed to along with timestamps, ad types, and placement context. The attribution component 136 can use the AI model to distribute the overall incrementality across the individual advertising touches based on their characteristics, thereby determining how each touch contributed to the incremental outcome. The AI model (e.g., as described with respect to FIG. 7) can make a prediction of the incrementality for each touch, and the attribution component 136 can estimate the attribution for each touch based on the predicted incrementality contribution. With the incrementality count established by the post-hoc quasi-experimental design, the attribution component 136 can adjust the output of the AI model to ensure that the sum of the individual touch attributions equals the total attributed events (incrementality plus baseline), thereby fitting the observed impressions to incrementality and fully account for contribution, regardless of lost signals. In some embodiments, the AI model used by the attribution component 136 to distribute incrementality across individual touches can be the same AI model trained by the AI training component 132, or can be a separate model specifically trained to allocate incrementality contributions based on touch characteristics such as ad type, recency, placement context, and frequency.

In some embodiments, the attribution component 136 can use the attribution measurement to determine return on advertisement spend (ROAS) and/or return on investment (ROI). ROAS can be calculated by dividing the revenue generated from attributed conversions by the cost of the advertising. ROI can be calculated by subtracting the advertising cost from the revenue and dividing by the advertising cost. Incrementality can be used for multi-touch cross-channel ROAS and marginal cost per action analysis. In some embodiments, the attribution component 136 can provide the incrementality, the attribution, the ROAS, and/or the ROI to a user device (e.g., client device 120A-Z) for presentation in a user interface (e.g., in a dashboard displayed via user interface 124A-Z). In some embodiments, the attribution component 136 can use the attribution measurement to identify characteristics of users (or groups of users) who performed a KPI or conversion event, which advertisements they were exposed to that led to the KPI or conversion event, and/or recommendations to increase ROAS and/or ROI. The recommendations can include which advertisements to target to which user(s), at what time and through which channels, for example.

In some embodiments, the attribution component 136 can use the spend-normalized attribution and incrementality measurements to generate recommendations for optimizing advertising budget allocation. For example, the attribution component 136 can identify placements with low spend-normalized marginal cost per action (indicating high efficiency for incremental investment) and/or placements with high spend-normalized marginal cost per action (indicating low efficiency for incremental investment). In some embodiments, the attribution component 136 can generate recommendations to shift budget from placements with high marginal cost per action to placements with low marginal cost per action to maximize incremental conversions for the same total advertising spend. The recommendations can be provided to a user device (e.g., client device 120A-Z) for review and implementation, in embodiments.

In some embodiments, the multi-touch attribution module 111 can perform source of truth validation to verify the accuracy of attribution measurements by comparing data across multiple data sources. Source of truth validation can involve comparing impression data and conversion data received from different partners or data providers to identify discrepancies and ensure that the attribution measurements are based on accurate and consistent data.

In some embodiments, the source of truth validation can compare impression counts, conversion counts, and/or attributed conversion counts between a first data source (e.g., a first advertising partner) and a second data source (e.g., a second advertising partner or an internal measurement system). The multi-touch attribution module 111 can identify discrepancies between the data sources, such as differences in total impression counts, differences in conversion counts, and/or differences in the timing of recorded events. In some embodiments, discrepancies can arise from differences in time zone handling, where one data source records events in a first time zone and another data source records events in a second time zone. The source of truth validation can account for time zone differences when comparing data across sources.

In some embodiments, the source of truth validation can identify when a data source is under-reporting or over-reporting impressions or conversions relative to other data sources. For example, if a first data source reports significantly fewer conversions than a second data source for the same campaign, the source of truth validation can flag this discrepancy for investigation. The multi-touch attribution module 111 can use the source of truth validation to identify data quality issues that could affect the accuracy of the attribution and incrementality measurements.

In some embodiments, the source of truth validation can be used in conjunction with the lost signal recovery component 134 to identify and quantify lost signals. By comparing the attributed conversions reported by a data partner against the total conversions measured by the multi-touch attribution module 111, the source of truth validation can identify the magnitude of signal loss and inform the calculation of lost signal projection factors. The results of the source of truth validation can be stored in data store 140 and provided to a user device (e.g., client device 120A-Z) for review.

In some embodiments, the multi-touch attribution module 111 can determine marginal cost per action (mCPA) by analyzing the relationship between advertising frequency and cumulative lift. Cumulative lift can refer to the aggregate increase in conversions (or conversion rate) attributable to advertising impressions at a given frequency level. Cumulative lift can represent the total incremental effect of advertising accumulated across all impressions up to and including the current frequency. For example, if a user has been exposed to an advertisement three times, the cumulative lift at frequency three represents the total incremental conversions attributable to all three exposures combined. Cumulative lift typically follows a diminishing returns pattern, where initial advertising exposures produce substantial lift but subsequent exposures yield progressively smaller incremental gains. The multi-touch attribution module 111 can generate a frequency to lift response function that plots the cumulative conversion rate against the frequency of advertising impressions. Example frequency to life response function plots are described with respect to FIGS. 6A and 6B. The frequency to lift response function can demonstrate a diminishing returns pattern, where the cumulative lift increases rapidly at lower frequencies and then gradually flattens as frequency increases, indicating diminishing marginal returns from additional advertising impressions.

In some embodiments, the multi-touch attribution module 111 can fit a best fit equation to empirically observed data points representing cumulative lift values at various frequency levels. The best fit equation can produce a close estimate to what was empirically observed for the campaign at any frequency. The best fit equation can be a logarithmic function, a saturation function, or another suitable mathematical function that models the diminishing returns relationship between frequency and lift.

In some embodiments, the multi-touch attribution module 111 can calculate the marginal cost per action by examining the slope of the frequency to lift response function at any given frequency level. The slope of the curve at a particular frequency represents the marginal conversions expected from one additional unit of frequency. If the current frequency is a first value (e.g., 3), the multi-touch attribution module 111 can calculate the marginal conversions by determining the cumulative conversions at an incremented frequency (e.g., 4) and subtracting the cumulative conversions at the current frequency (e.g., 3). The difference represents the marginal conversions that would result from purchasing one additional unit of frequency.

In some embodiments, the multi-touch attribution module 111 can determine the marginal cost per action by dividing the cost of the additional frequency by the marginal conversions. The cost of the additional frequency can be based on the cost per thousand impressions (CPM) for the advertisement placement. Dividing the marginal conversions by the CPM produces the marginal cost per action (mCPA). The mCPA represents the cost to acquire one additional conversion at the current frequency level.

In some embodiments, the multi-touch attribution module 111 can use the marginal cost per action analysis to determine where the next dollar of advertising investment should be allocated. Different advertisement placements may be at different points on the diminishing returns curve. A first placement may be at a lower frequency position on the curve where the slope is still relatively steep, indicating higher marginal returns from additional advertising investment. A second placement may be at a higher frequency position where the curve has substantially flattened, indicating that the placement has reached or passed the point of diminishing returns where additional spending would yield minimal incremental conversions.

In some embodiments, the multi-touch attribution module 111 can compare the marginal cost per action across multiple advertisement placements to identify the placements with the highest marginal returns. A placement with a lower marginal cost per action represents a more efficient use of advertising budget than a placement with a higher marginal cost per action. The multi-touch attribution module 111 can generate recommendations to shift advertising budget from placements with high marginal cost per action (past the point of diminishing returns) to placements with low marginal cost per action (still on the steep portion of the curve).

In some embodiments, the marginal cost per action analysis differs from average cost per action (CPA) analysis. The average CPA is calculated by dividing the total cost of a placement by the total number of conversions attributed to that placement. While average CPA provides a backward-looking measure of overall efficiency, it may not indicate where the next dollar should be invested. A placement with a low average CPA may have a high marginal CPA if the placement is past the point of diminishing returns. Conversely, a placement with a higher average CPA may have a lower marginal CPA if the placement is still on the steep portion of the curve. The multi-touch attribution module 111 can provide both average CPA and marginal CPA to enable advertisers to make informed decisions about future advertising investments.

In some embodiments, the multi-touch attribution module 111 can normalize the frequency to lift response function to enable comparison of different advertisement placements at different frequency levels. Since advertising impact has a diminishing returns signature by frequency, comparing two placements to determine which is more impactful should be done using a normalized frequency (such as relative impact at a frequency of 1.0). The normalization component 135 can apply frequency normalization to the attribution and incrementality measurements to enable like-for-like comparison of placements operating at different frequency levels.

In some embodiments, the multi-touch attribution module 111 can provide a what-if simulator that allows advertisers to adjust the cost per thousand impressions (CPM) to determine the impact of cost changes on the marginal cost per action. Since CPM can be negotiated, advertisers may need to consider how changes in CPM affect the shape of the frequency to lift response function and, therefore, which placement should receive the next dollar of investment. The multi-touch attribution module 111 can provide placement-level equations to calculate marginal return, enabling advertisers to power such a simulator and optimize their advertising budget allocation.

In some embodiments, the multi-touch attribution module 111 can provide the marginal cost per action, the frequency to lift response function, and/or the what-if simulator results to a user device (e.g., client device 120A-Z) for presentation in a user interface (e.g., in a dashboard displayed via user interface 124A-Z). The user interface can display the current frequency level for each placement, the marginal cost per action at the current frequency, and recommendations for reallocating budget to maximize incremental conversions.

In some embodiments, the multi-touch attribution module 111 can include a KPI classification component configured to classify key performance indicators (KPIs) using artificial intelligence. The KPI classification component can allow an advertiser to create as many KPIs as desired and to label them in whatever manner suits the advertiser. The KPI classification component can apply AI to analyze the KPI type and to assign it to a classification taxonomy.

In some embodiments, the classification taxonomy can include categories such as Purchase, Sign-up, Page View, and/or other standardized KPI types. The AI-based classification can analyze the characteristics of each advertiser-defined KPI and determine which category in the classification taxonomy best corresponds to the KPI. This enables the multi-touch attribution module 111 to standardize KPIs across different advertisers and campaigns, even when advertisers use different naming conventions or labeling schemes for similar types of conversion events.

In some embodiments, the KPI classification component can employ machine learning algorithms to classify advertiser-defined KPIs into the classification taxonomy. The machine learning algorithms can include supervised learning methods such as decision trees, support vector machines, neural networks, k-nearest neighbors classifiers, naive Bayes classifiers, random forests, gradient boosting models, or logistic regression classifiers. In some embodiments, the KPI classification component can use natural language processing (NLP) techniques to analyze the text of advertiser-defined KPI labels and descriptions to determine the appropriate classification category. The NLP techniques can include text tokenization, word embedding, semantic analysis, and/or pattern matching to identify keywords and phrases indicative of particular KPI types.

In some embodiments, the KPI classification component can be trained using supervised learning methods wherein the classifier is trained on labeled training data comprising advertiser-defined KPI labels paired with corresponding classification categories. The training data can include historical KPIs that have been manually classified into the classification taxonomy. In some embodiments, the KPI classification component can employ semi-supervised learning methods that utilize both labeled and unlabeled data, enabling the classifier to learn from a smaller set of labeled examples while leveraging patterns in a larger set of unlabeled advertiser-defined KPIs.

In some embodiments, the KPI classification component can analyze features of the KPI beyond the advertiser-defined label, including the type of conversion event (e.g., click, form submission, transaction), the data fields associated with the conversion event (e.g., transaction amount, product category, page URL), and/or the context in which the KPI is used (e.g., e-commerce, lead generation, content engagement). The KPI classification component can extract these features and provide them as input to the machine learning classifier to improve classification accuracy.

In some embodiments, the KPI classification performed by the AI can enable benchmarking of advertising effectiveness across campaigns and advertisers. By classifying advertiser-defined KPIs into standardized categories, the multi-touch attribution module 111 can compare attribution and incrementality measurements for similar KPI types across different campaigns. For example, the multi-touch attribution module 111 can compare the performance of campaigns with Purchase KPIs against benchmarks derived from other campaigns with Purchase KPIs, regardless of how individual advertisers labeled their KPIs. The standardized classification also enables the multi-touch attribution module 111 to apply category-specific analysis techniques, such as different lookback windows or attribution models optimized for particular KPI types.

In some embodiments, the KPI classification can be stored in conversion event data 143 of data store 140. The conversion event data 143 can include both the advertiser-defined KPI label and the AI-assigned classification category for each conversion event. The attribution component 136 can use the AI-assigned classification category when generating benchmark comparisons and performance reports for presentation to a user device (e.g., client device 120A-Z). In some embodiments, the KPI classification component can provide a confidence score indicating the certainty of the classification, and can flag KPIs with low confidence scores for manual review.

In some embodiments, the multi-touch attribution module 111 can identify and filter bot traffic from the tracking data 141 prior to performing attribution and incrementality analysis. Bot traffic can refer to automated requests or interactions generated by software programs (bots) rather than human users. Bot traffic can artificially inflate impression counts, click counts, and/or other engagement metrics, which can distort attribution measurements and lead to inaccurate incrementality calculations.

In some embodiments, a bot traffic identification and removal component can analyze the tracking data 141 to identify patterns indicative of bot activity. Bot traffic patterns can include abnormally high request rates from a single IP address, interactions occurring at regular intervals suggesting automated behavior, user agent strings associated with known bot programs, interactions originating from data centers rather than residential or commercial IP addresses, and/or interactions that lack typical human browsing patterns (e.g., no mouse movements, no scroll events, impossibly fast navigation between pages).

In some embodiments, the bot traffic identification and removal component can maintain a database of known bot signatures, including IP addresses, user agent strings, and/or behavioral patterns associated with bot activity. The bot traffic identification and removal component can compare incoming tracking data 141 against the database of known bot signatures to identify and flag suspected bot traffic. In some embodiments, the bot traffic identification and removal component can use machine learning techniques to identify previously unknown bot patterns based on anomalous behavior that deviates from typical human interaction patterns.

In some embodiments, the bot traffic identification and removal component can remove identified bot traffic from the tracking data 141 before the incrementality engine 131 performs the post-hoc comparative analysis. By removing bot traffic, the multi-touch attribution module 111 can ensure that the incrementality measurements and attribution measurements are based on genuine human interactions, thereby improving the accuracy of the multi-touch attribution analysis. In some embodiments, the bot traffic identification and removal component can generate a report indicating the volume and characteristics of bot traffic identified and removed, which can be provided to a user device (e.g., client device 120A-Z) for review.

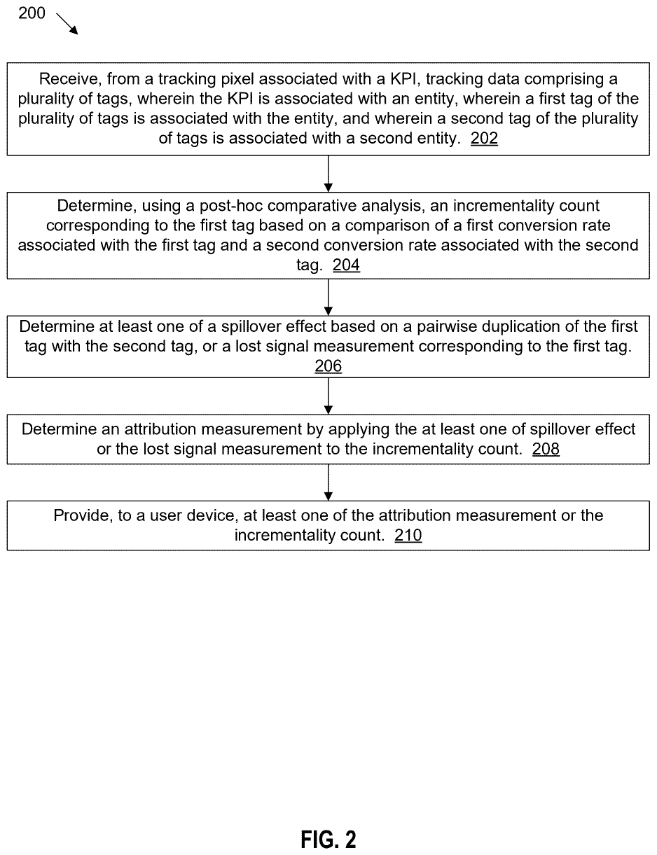

FIG. 2 depicts a flow diagram of a method 200 for determining multi-touch attribution, in accordance with one or more aspects of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 may be performed by the multi-touch attribution module 111 of FIG. 1. In some embodiments, the method 200 may be executed by one or more processing devices of the server 112, to be presented to client devices 120A-120Z.

For simplicity of explanation, the method 200 of this disclosure is depicted and described as a series of acts. However, acts in accordance with this disclosure can occur in various orders and/or concurrently, and with other acts not presented and described herein. Furthermore, not all illustrated acts may be required to implement the method 200 in accordance with the disclosed subject matter. In addition, those skilled in the art will understand and appreciate that the method 200 could alternatively be represented as a series of interrelated states via a state diagram or events. Additionally, it should be appreciated that the method 200 disclosed in this specification are capable of being stored on an article of manufacture (e.g., a computer program accessible from any computer-readable device or storage media) to facilitate transporting and transferring such method to computing devices.

At operation 202, processing logic receives, from a tracking pixel associated with a KPI, tracking data. In some embodiments, the tracking data can be sent from the pixel upon a triggering event, and optionally stored in a data store such as data store 140 of FIG. 1. In some embodiments, the tracking pixel may include code embedded on at least one of a website or a digital advertisement, and the tracking pixel may be configured to collect data about user activity comprising at least one of clicks, purchases, form submissions, website visits, time spent on pages, and/or email interactions, for example. In some embodiments, the tracking data may include a timestamp, an IP address, a device type, a browser type, and/or a referrer URL associated with a triggering event. The triggering event may occur when a user opens an email, makes a purchase, submits a form, accesses a website, and/or performs another trackable action.

The tracking data can include a plurality of tags. For example, the pixel can track user activity leading up to the KPI event (e.g., a conversion), and can send a tag for each user action in the user activity. In some embodiments, each tag can represent an advertisement to which a user was exposed prior to a conversion event (e.g., presented to the user in the user activity leading up the KPI event). Each tag can correspond to a particular entity. The KPI can be associated with an entity, and at least one of the plurality of tags (e.g., a first tag) can be associated with the entity. A second tag of the plurality of tags can be associated with a second entity that is different from the entity. The relationship between the KPI pixel and the plurality of tags, including entity tags and placebo tags from concurrent campaigns, is illustrated in FIG. 3.

In some embodiments, the plurality of tags may include tags representing advertisements from a plurality of concurrent advertising campaigns, and each tag may be associated with the tracking pixel when a user is exposed to a corresponding advertisement prior to the conversion event. A first tag of the plurality of tags may be associated with an entity (e.g., Brand X), and a second tag of the plurality of tags may correspond to a concurrent advertising campaign from a second entity different from the entity (e.g., Brands A, B, C, D, etc.). The second tag may serve as a placebo control in a post-hoc comparative analysis. In some embodiments, the plurality of tags comprises tags associated with at least two different media channels, such as digital media, broadcast media, podcast media, direct mail, or streaming media.

In some embodiments, consumers provide consent to tracking technologies (e.g., by opting in to cookies or privacy settings), and/or can opt-out of tracking technologies. In some embodiments, tracking data is anonymized to protect personal identities. The tracking data may include consent indicators representing whether a user has opted in or opted out of tracking technologies.

In some embodiments, processing logic normalizes the plurality of tags based on a reach associated with the first tag. The reach may correspond to a period of time (e.g., a seven-day lookback window). In some embodiments, the reach corresponds to a rolling reach calculated over a the lookback window.

In some embodiments, processing logic can normalize the plurality of tags for measurement grain differences between person-level digital data and regional-level broadcast data by applying a normalization factor derived from empirical analysis of campaigns analyzed using different measurement grains.

In some embodiments, the normalization factor is derived by analyzing a plurality of digital campaigns using a person-level grain, analyzing the same plurality of digital campaigns using a regional-level grain, and determining the normalization factor based on a difference in attribution signal between the person-level grain and the regional-level grain. This normalization enables like-for-like comparison of attribution measurements across different media channels. A standard regression of DMA to household level attribution and incrementality normalizes the results so that one can make side-by-side comparisons of conversions, cost per conversion, and marginal conversions.

In some embodiments, normalizing the plurality of tags based on the reach can include applying frequency normalization to enable comparison of advertisement placements at different frequency levels based on a relative impact at a normalized frequency (such as relative impact at a frequency of 1.0). Since advertising impact has a diminishing returns signature by frequency, comparing two placements to determine which is more impactful should be done using the normalized frequency.

In some embodiments, processing logic determines a privacy consent projection factor based on a percentage of users who opted in to tracking versus a percentage of users who opted out of tracking. Processing logic may count total impressions and calculate the percent of time the macro expands, as well as aggregated data features of those that consented versus those that did not, to produce the privacy consent projection factor that minimizes bias. Processing logic may apply the privacy consent projection factor to the attribution measurement to account for signal loss due to privacy opt-outs.

At operation 204, processing logic determines, using a post-hoc comparative analysis, an incrementality count corresponding to the first tag based on a comparison of a first conversion rate associated with the first tag and a second conversion rate associated with the second tag. The second tag can serve as a control in the post-hoc comparative analysis. The incrementality count represents the increase in conversions (the number of conversions, or the conversion rate) that is attributable to the advertisements associated with the first tag.

In some embodiments, the post-hoc comparative analysis includes a post-hoc randomized controlled test (PHRCT) and/or a post-hoc quasi-experimental design (PHQED). The PHRCT can use randomized sampling of concurrent campaigns, in embodiments. PHRCT may be used when there are sufficient concurrent campaigns to randomly sample an adequate number of advertisements for statistical reliability. The PHQED can include matching control groups based on ad size and targeting parameters using at least one of entropy balancing or iterative proportionate fit weighting. PHQED may be used when the number of campaigns running concurrently is insufficient to provide a statistically reliable randomized sample, and instead matched control groups are selected based on similar ad size and targeting parameters.

In some embodiments, to determine the incrementality count processing logic can apply bootstrap methods with shuffle sampling to the plurality of tags to measure a degree to which the first tag is more associated with the KPI compared to a random sample of other tags in the plurality of tags. The bootstrap method with shuffle sampling for signal robustness measures the degree to which the advertiser's tag is more associated with the KPI compared to a random sample of other tags (e.g., tags not associated with the advertiser). The shuffle sampling may include randomly duplicating the plurality of tags to confirm that the first tag is statistically significantly higher than the second tag to an extent corresponding to an incremental impact from advertisements associated with the first tag.

In some embodiments, processing logic provides, as input to an AI model, the plurality of tags and an identifier of the entity. The AI model can be trained to output an incrementality count corresponding to the first tag. Processing logic can receive, as output from the AI model, the incrementality count corresponding to the first tag. In some embodiments, the AI model can combine bootstrapping, shuffle sampling, and/or random duplication. The AI model may be trained using at least two of bootstrapping, shuffle sampling, or random duplication techniques, in embodiments. The AI model may include a linear regression model, a neural network, a decision tree, a support vector machine, and/or a gradient boosting model configured to fit input features to incrementality data.

In some embodiments, processing logic can gather campaign data during a first time period of an advertisement campaign (e.g., during the first week of the campaign). As an illustrative example, in some cases, it may take approximately four days of computation to process patterns of exposure and conversion for a campaign, feeding on the first week of campaign data, after which an incrementality model becomes available. Processing logic can train or fine-tunes the AI model based on the campaign data gathered during the first time period, and can execute the trained AI model for a remainder of the advertisement campaign to generate incrementality counts. As more data is collected throughout the campaign, processing logic may continue to fine-tune the AI model and adjust the attribution estimates accordingly.

In some embodiments, processing logic can perform benchmark analysis on a plurality of completed campaigns to generate benchmark learning. The benchmark learning may then be used as priors in a Bayesian model. Processing logic applies the Bayesian model to generate real-time attribution estimates for a current campaign. This enables faster calculation and delivery of results in near real-time while the more computationally intensive incrementality analysis is being performed.

In some embodiments, processing logic can determine a baseline attribution by multiplying a reach of advertisements associated with the first tag by a total number of conversion events during a lookback window. The baseline represents the expected conversions if the advertisement has no effect at all. If the incrementality has been measured, it should be higher than the baseline number. Determining the attribution measurement may comprise combining the incrementality count with the baseline attribution to determine total attributed events. The incremental difference plus the baseline is the total attributed events.

At operation 206, processing logic determines at least one of a spillover effect or a lost signal measurement corresponding to the first tag. In some embodiments, processing logic can perform a pairwise duplication of the first tag with the second tag. In some embodiments, processing logic can perform a pairwise duplication of the first tag with each of the other tags in the plurality of tags. The pairwise duplication can represent the spillover effect.

In some embodiments, to determine the spillover effect, processing logic can perform a pairwise duplication analysis of the first tag with each of a plurality of other tags in the plurality of tags to identify overlapping exposures between the entity and other entities. A spillover effect occurs when an event or action that occurs in one context causes unintended consequences in another. That is, the impact of an advertisement (or the impact of exposure to a media content item) can extend beyond its intended audience or brand. The spillover effect reduces the appearance of incrementality because it dilutes the measured effect.

In some embodiments, performing the pairwise duplication analysis can include determining a spillover-adjusted placebo exposure by subtracting a total number of impressions exposed to both the first tag and the second tag from a total number of impressions exposed to the second tag. This adjusts the placebo group size downward, removing the portion of overlap with the advertiser's audience. Processing logic may calculate a spillover bias as a ratio of the pairwise duplication to a total placebo exposure, multiplied by a measured placebo lift. Processing logic may calculate a spillover-corrected incremental lift by subtracting the spillover bias from an incremental lift measured before spillover adjustment. When tracking across multiple placebo tags, processing logic may sum the contributions of each placebo tag to determine the total spillover bias, and may adjust the advertiser lift by subtracting the cumulative spillover bias. Correcting for spillover effects enhances the accuracy of incrementality by isolating the true causal effect of the advertiser's campaign, thus avoiding over-attribution and strengthening causal claims.

In some embodiments, to determine the lost signal measurement, processing logic can determine a traditional incrementality count (e.g., determine an incrementality count using traditional methods, such as a forward-tracking attribution method). Processing logic can determine a difference between the incrementality count (e.g., from the post-hoc comparative analysis) and the traditional incrementality count. The difference can represent the lost signal measurement.

In some embodiments, to determine the lost signal measurement, processing logic can determine a first metric value for a first subset of the plurality of tags. The first subset can correspond to the entity. That is, the first metric is associated with the advertiser tags for the advertiser. Processing logic can determine a second metric value for a second subset of the plurality of tags. The second subset does not correspond to the entity. That is, the second metric value is associated with the advertiser tags of the control group. Processing logic can determine the difference between the first metric value associated with the advertiser tags for the advertiser and the second metric value associated with the advertiser tags of the control group, and the difference can represent the lost signal measurement. The metric (e.g., the first metric, the second metric) can represent an index of conversions per reach, for example. An index of conversions per reach can represent the conversion rate normalized by the number of people exposed to the advertisements (e.g., conversions divided by reach). This normalized metric enables fair comparison between the advertiser group and the control group regardless of differences in campaign size or audience reach. Lost signal events, such as anonymous or opt-out activity, are generally approximately the same in the control as in the advertiser groups. Thus, processing logic can determine the overall incrementality, which is inclusive of the lost signal effect, and then distribute the incrementality across the number of attributed events for a particular conversion event.

In some embodiments, the lost signal measurement accounts for at least one of anonymous online actions (e.g., accessing the internet on a public computer without providing any identifier), opt-out tracking actions (e.g., selecting an “Ask App not to Track” option), or cross-device signal loss occurring when a user is exposed to an advertisement on a first device and performs the conversion event on a second device different from the first device. For example, a user may see an impression in one environment (e.g., on their cell phone using a public Wi-Fi connection) and convert in a different environment (e.g., on their home computer using a cable connection), thus looking as if the conversion was not caused by the impression.

In some embodiments, processing logic determines a lost signal projection factor based on the lost signal measurement, and scales the attribution measurement by the lost signal projection factor to account for untrackable interactions. The post-hoc nature of the techniques described herein provides for a total incrementality that can be measured by measuring the difference between a metric value associated with the advertiser tags for the advertiser and a metric value associated with the advertiser tags for the control advertisements. Since the ratio is observed overall, the problem of lost signal that occurs with tracing the connection of impressions to conversion is overcome.

At operation 208, processing logic determines an attribution measurement by applying the spillover effect and/or the lost signal measurement to the incrementality count. In some embodiments, the spillover effect can be subtracted from the incrementality count. In some embodiments, the lost signal measurement can be added to the incrementality count.

Attribution can refer to the opportunity of a promotional message (or set of promotional messages) to influence a conversion event. Attribution can show the touchpoints at which a consumer has been exposed to a promotional message(s) and subsequently converted. Incrementality can represent the subset of the attributable conversions that were caused by the advertisement. In some embodiments, processing logic combines the incrementality count with a baseline attribution to determine total attributed events, and then adjusts the total attributed events for the spillover effect and/or the lost signal measurement to determine the final attribution measurement. With the incrementality count established, processing logic can adjust the output of the AI model to fit the observed impressions to incrementality and fully account for contribution, regardless of lost signals.

In some embodiments, the incrementality (or incremental lift) can be measured as the conversion rate of the treatment group (e.g., of a group of users exposed to the advertisement or campaign associated with the KPI event) minus the conversion rate of a randomized control group, divided by the conversion rate of the randomized control group (e.g., (conversion rate of the treatment group minus conversion rate of the control group) divided by the conversion rate of the control group). Note that the any metric can be used in place of the conversion rate, such as sales, number of conversions, engagement, etc. Spillover can occur in a randomized controlled test when impressions for the randomized control group are also delivered to the treatment group, or vice-versa, when impressions for the treatment group are also delivered to the control group. Spillover can happen when randomization is by impressions rather than by person, when a person moves between groups (such as when an experiment is conducted at the city level, and a person travels from one city to another during the course of the experiment), or in a number of other situations. In advertising, where the effect is one-directional (e.g., advertising increases the propensity to convert), the spillover effect can reduce the incremental lift observed in proportion to the amount of spillover. In some embodiments, the incremental lift can be a weighted average of the impressions with spillover and the impressions without spillover. Therefore, processing logic can measure the degree of spillover and apply a spillover adjustment to recover the incremental lift.

As an illustrative example, a first group of users (2.9 million users) can be exposed to a first campaign, and 1.2 million users of the first group can also be included in the randomized control group. Thus, the first campaign has significant overlap with the randomized control group.

To the extent that the overlapping group (e.g., the 1.2 million users) is treated as part of the randomized control group, it will raise the baseline for the control group.

In some embodiments, processing logic can determine the amount of overlap, and using the amount of overlap, can determine a spillover effect adjustment. Processing logic can apply the spillover effect adjustment to adjust the incrementality count.

In some embodiments, processing logic can determine the spillover-adjusted placebo exposure as follows:

$${N}_{P}^{*} = {N}_{P} - {N}_{A P} , where {N}_{P}^{*}$$

represents the spillover-adjusted placed exposure, N_{P} represents the total impressions (or users) exposed to the placebo tag (e.g., tag in the tracking pixel for an advertiser not associated with the KPI event), and N_{AP} represents the total impression (or users) exposed to both the advertiser tag and the placebo tag (e.g., pairwise publication). This adjusts the placebo group size downward, removing the portion of overlap with the advertiser's audience.

The spillover-corrected incremental lift can be calculated as:

$${L}_{A}^{*} = {L}_{A} - \frac{{N}_{A P}}{{N}_{P}} \cdot {L}_{P} , where {L}_{A}^{*}$$

represents the spillover-corrected incremental lift, L_{A} represents the incremental lift measured before spillover adjustment, and L_{P} represents the measured placebo lift before adjustment. The term

$$\frac{{N}_{A P}}{{N}_{P}} \cdot {L}_{P}$$

represents the spillover bias in the placebo group. This equation can reduce the advertiser's incremental lift by removing the contribution of the overlapping placebo users.

In some embodiments, processing logic can scale for multiple placebo tags. When tracking across multiple placebo tags (i), processing logic can sum their contributions as follows:

$$Total Spillover Bias = {\sum }_{i} ( \frac{{N}_{A P}^{i}}{{N}_{P}^{i}} \cdot {L}_{P}^{i} ) .$$

Processing logic can adjust the advertiser lift by subtracting the cumulative spillover bias.

Lost signals can be caused by a combination of the flow forward nature of traditional attribution and the nature of users using various devices and various methods to connect to the Internet, such as cable connections at home, cellular away from home, public Wi-Fi connection, and so on. As an illustrative example, a user may see an impression in one environment (e.g., on their cell phone using a public Wi-Fi connection) and convert in a different environment (e.g., on their home computer using a cable connection), thus looking as if the conversion was not caused by the impression. In this example, the impression the user first saw on their cell phone may not be attributed to the conversion. The impression is a lost signal. The PHRTC method described herein solves for this lost signal using the radio of impressions to conversion to the advertiser's tracking pixel (or offline sales, or other KPI) for the advertiser, as well as for the randomized set of other advertisers (e.g., advertisements from Brands A, B, C, D, etc., as described above). Since the ratio is observed overall, the problem of lost signal that occurs with tracing the connection of impressions to conversion is overcome. With the incrementality count established, processing logic can adjust the output of the AI model to fit the observed impressions to incrementality and fully account for contribution, regardless of lost signals.

In some embodiments, processing logic determines a return on advertisement spend (ROAS) and/or a return on investment (ROI) based on the attribution measurement. ROAS can be calculated by dividing the revenue generated from the attributed conversions by the total cost of the advertising campaign. For example, if the attribution measurement indicates 1,500 attributed conversions, and each conversion has an average revenue value of $50, the total revenue would be $75,000. If the total advertising spend was $15,000, the ROAS would be $75,000 divided by $15,000, resulting in a ROAS of 5.0, meaning the advertiser received $5 in revenue for every $1 spent on advertising. ROI can be calculated by subtracting the total advertising cost from the total revenue generated by the attributed conversions, and then dividing the result by the total advertising cost. Using the same example, the ROI would be calculated as ($75,000-$15,000) divided by $15,000, resulting in an ROI of 4.0 or 400%, meaning the advertiser received a 400% return on their advertising investment.

In some embodiments, processing logic can determine ROAS and ROI based on the incrementality count rather than the total attribution measurement to provide a measure of the true return from advertising. Because the incrementality count represents only the conversions that were caused by the advertising (excluding baseline conversions that would have occurred without advertising), the incremental ROAS and incremental ROI can provide a more conservative and accurate measure of advertising effectiveness. For example, if the incrementality count is 500 conversions (out of 1,500 total attributed conversions), the incremental revenue would be $25,000, and the incremental ROAS would be $25,000 divided by $15,000, resulting in an incremental ROAS of 1.67.

In some embodiments, processing logic generates a recommendation to increase the attribution measurement based on at least one of which advertisements to target to which users, at what time to deliver advertisements, and/or through which channels to deliver advertisements. In some embodiments, processing logic can generate the recommendations by analyzing the attribution and incrementality measurements across different segments, placements, time periods, and/or channels to identify patterns associated with higher conversion rates and lower marginal cost per action. The recommendations can include which advertisements to target to which user(s), at what time and through which channels, for example.

In some embodiments, processing logic can generate audience targeting recommendations by analyzing which user segments have the highest conversion rates when exposed to advertising. Processing logic can compare the conversion rates across different demographic segments, behavioral segments, and/or classifications to identify the segments most likely to convert when reached with advertisements. For example, if the attribution analysis indicates that a first user segment has a conversion-to-impression ratio that is significantly higher than a second user segment, processing logic can generate a recommendation to increase the proportion of advertising budget allocated to the first user segment. In some embodiments, processing logic can recommend an 80/20 budget split, where 80 percent of the budget is allocated to the segments most likely to incrementally convert and 20 percent is allocated to the remaining segments to maintain audience coverage.

In some embodiments, processing logic can generate timing recommendations by analyzing the attribution and incrementality measurements across different time periods, such as time of day, day of week, and/or time relative to specific events. Processing logic can identify time periods during which advertisements produce higher incremental conversions and can recommend increasing advertisement delivery during those time periods while reducing delivery during lower-performing time periods.

In some embodiments, processing logic can generate channel recommendations by analyzing the attribution and incrementality measurements across different media channels, such as digital display, video, podcast, broadcast, and/or direct mail. Processing logic can use the normalized attribution measurements (which account for measurement grain differences across channels) to compare the performance of different channels on a like-for-like basis. Processing logic can identify channels with lower marginal cost per action and can recommend shifting budget from channels that have reached the point of diminishing returns (as illustrated in FIG. 6B) to channels that are still on the steep portion of the frequency to lift response curve (as illustrated in FIG. 6A).

In some embodiments, processing logic can generate advertisement creative recommendations by analyzing which advertisement messages, formats, and/or creative versions produce higher incremental conversions. Processing logic can compare the attribution and incrementality measurements across different advertisement versions to identify the messages most likely to resonate with each user segment and can recommend delivering the most effective messages to each target audience.

At operation 210, processing logic provides, to a user device (e.g., client device 102A-Z of FIG. 1), at least one of the attribution measurement or the incrementality count. In some embodiments, processing logic provides, to the user device, the ROAS and/or the ROI. In some embodiments, processing logic provides, to the user device, the recommendation to increase the attribution measurement. In some embodiments, the user device can display the attribution measurement, the incrementality count, the ROAS, the ROI, and/or the recommendation, e.g., in a dashboard displayed via user interface 124A-Z (e.g., in a dashboard displayed via UI 124A-Z). In some embodiments, the recommendations can be automatically implemented by transmitting audience adjustments, timing adjustments, and/or channel allocation adjustments to a media owner or advertising platform without requiring additional work from the advertising agency or advertiser.

FIG. 3 illustrates a diagram showing the relationship between a KPI pixel 301 and multiple tags associated with the KPI pixel 301, in accordance with one or more aspects of the present disclosure. The KPI pixel 301 is depicted as a central element connected to multiple placebo tags and an entity tag.

As illustrated in FIG. 3, the KPI pixel 301 is connected to multiple placebo tags 303A-Z. The KPI pixel 301 is also connected to an entity tag 305. The placebo tags 303A-Z represent advertisements from concurrent campaigns not associated with the conversion event tracked by the KPI pixel 301. The entity tag 305 represents an advertisement from a marketing campaign associated with the conversion event.

In some embodiments, the KPI pixel 301 can represent a tracking pixel. A tracking pixel can be a small piece of code embedded on a website or digital advertisement to collect data about user activity and interactions. The KPI pixel 301 can track which advertisements a user was exposed to prior to a conversion event. The advertisements that the user was exposed to prior to the conversion event may include advertisements from a marketing campaign associated with the conversion event, represented by the entity tag 305, as well as advertisements from marketing campaigns not associated with the conversion event, represented by the placebo tags 303A-Z. Each advertisement can be represented by a tag associated with the KPI pixel 301. Thus, the KPI pixel 301 can be associated with multiple tags from multiple campaigns.

In some embodiments, from the perspective of the KPI pixel 301, the multiple tags associated with the pixel will exhibit characteristics close to random duplication. That is, the placebo tags 303A-Z will be distributed among conversion events in a manner that approximates random chance, with any variance from random duplication being attributable to audience similarity between campaigns. The entity tag 305, however, should be statistically significantly more associated with conversion events than the placebo tags 303A-Z, to the extent that there is incremental impact from the advertisements associated with the entity.

In the post-hoc comparative analysis described herein, the placebo tags 303A-Z serve as control advertisements, similar to placebo advertisements in a controlled experiment. The multi-touch attribution module 111 of FIG. 1 can compare data associated with the entity tag 305 to a randomized sample of the placebo tags 303A-Z to determine an incrementality count corresponding to the entity tag 305. The incrementality engine 131 of the multi-touch attribution module 111 can use bootstrap methods with shuffle sampling to measure the degree to which the entity tag 305 is more associated with the KPI compared to a random sample of the placebo tags 303A-Z.

In some embodiments, the multi-touch attribution module 111 can normalize the tags 303A-Z, and 305 for their reach. The normalization component 135 can normalize the tags for impression scale and unique reach to enable accurate comparison between the entity tag 305 and the placebo tags 303A-Z. The incrementality measurement can be produced by comparing the conversion rate associated with the entity tag 305 with the conversion rate associated with the randomized sample of placebo tags 303A-Z. The conversion rate of the randomized sample of placebo tags can be referred to as the control.

In some embodiments, the spillover correction component 133 of the multi-touch attribution module 111 can perform pairwise duplication analysis by examining the overlap between the entity tag 305 and each of the placebo tags 303A-Z. The pairwise duplication represents the number of users or impressions that were exposed to both the entity tag 305 and a particular placebo tag (e.g., placebo tag 303A). This overlap can cause spillover effects that dilute the measured incrementality. The spillover correction component 133 can calculate the spillover bias for each placebo tag and adjust the incremental lift accordingly to recover the true effect of the advertisements associated with the entity tag 305.

In some embodiments, the lost signal recovery component 134 of the multi-touch attribution module 111 can account for lost signals associated with the tags 303-Z, and 305. Lost signals may occur when a user is exposed to an advertisement represented by one of the tags but the exposure cannot be tracked due to anonymous online actions, opt-out tracking actions, or cross-device signal loss. Because lost signal events are generally approximately the same in the control (placebo tags 303A-Z, or a subset thereof) as in the advertiser group (entity tag 305), the post-hoc comparative analysis can determine the overall incrementality inclusive of the lost signal effect.

FIG. 3 illustrates an example data structure that enables the post-hoc quasi-experimental design described herein. By collecting and associating multiple tags from multiple concurrent campaigns with a single KPI pixel 301, the system can leverage existing advertising campaigns as control groups without requiring the expense of dedicated placebo advertisement campaigns. This approach provides a technical improvement over conventional attribution methods by enabling accurate incrementality measurement through comparison of the entity tag 305 against the naturally occurring distribution of placebo tags 303A-Z.

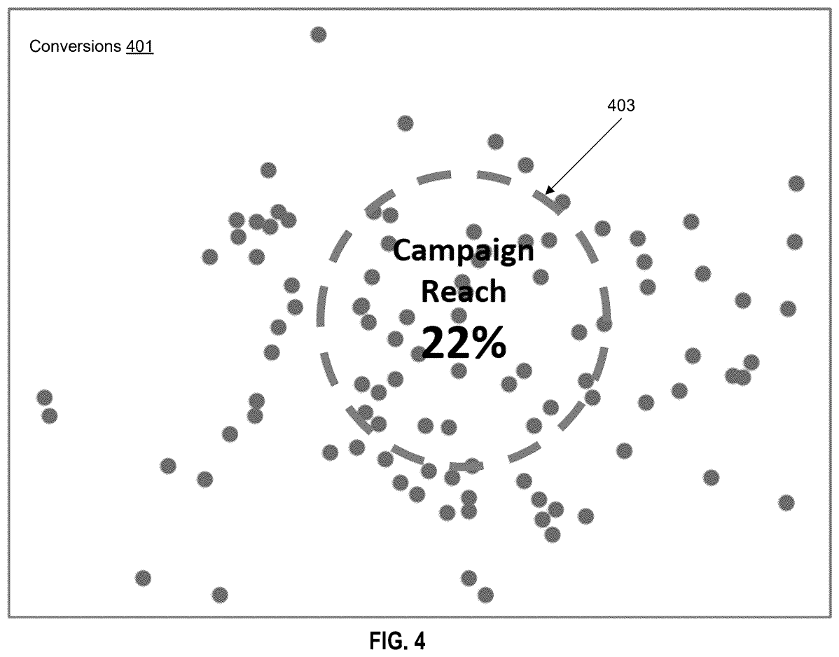

FIG. 4 depicts a diagram illustrating a campaign reach visualization for multi-touch attribution, in accordance with one or more aspects of the present disclosure. The diagram shows conversions 401 represented as a plurality of dots distributed across the visualization area. A dashed circular boundary defines a campaign reach 403 region in the center of the diagram. The campaign reach 403 is indicated as 22% and encompasses a subset of the conversions 401 that fall within the circular boundary. The conversions 401 are distributed both inside and outside the campaign reach 403 boundary, with the dots inside the boundary representing conversions that occurred among users reached by the advertising campaign, while the dots outside the boundary represent conversions that occurred among users not reached by the campaign.

In some embodiments, the multi-touch attribution module 111 can use an odds ratio test, also referred to as a random duplication test, to identify when under-attribution is occurring in the attribution measurement. The odds ratio test is based on the principle that the conversion rate among those exposed to the campaign should be equal to or greater than the conversion rate among the overall population. If advertising has any positive effect, the conversion rate among those reached by the campaign should be at least as high as the baseline conversion rate in the population. If the conversion rate among those exposed to the campaign is less than the baseline conversion rate in the overall population, this indicates that the attribution system is failing to properly connect advertising impressions to conversions, resulting in under-attribution.

In some embodiments, the odds ratio test can be performed by comparing the attributed conversion rate among those reached by the campaign (represented by the conversions 401 inside the campaign reach 403 boundary in FIG. 4) against the baseline conversion rate in the overall population (represented by all conversions 401). For example, if the background conversion rate for the population is 2%, one would expect that households exposed to the advertising campaign would purchase at least at a 2% rate within the lookback window. If less than 2% of impressions within the campaign reach 403 are attributed to a conversion in the lookback window, that is a clear indicator that the attribution system is failing to match impressions and conversions, resulting in under-attribution.

In some embodiments, the odds ratio can be calculated as the ratio of the attributed conversion rate among those reached by the campaign to the baseline conversion rate in the overall population. An odds ratio of 1.0 indicates that the attributed conversion rate equals the baseline rate, meaning the attribution system is connecting impressions to conversions at the expected baseline level. An odds ratio greater than 1.0 indicates that the attributed conversion rate exceeds the baseline rate, which is the expected result when advertising has a positive effect on conversions. An odds ratio below 1.0 indicates that the attributed conversion rate is lower than the baseline rate, which signals that the attribution system is failing to properly connect advertising impressions to conversions.

In some embodiments, when the odds ratio falls below 1.0, this indicates under-attribution, where advertisers do not receive fair accounting of their advertising value. Under-attribution can occur due to lost signals resulting from anonymous online actions, privacy opt-outs, cross-device signal loss, or other factors that prevent the attribution system from matching impressions to conversions. The lost signal recovery component 134 can use the odds ratio test to identify the presence and magnitude of under-attribution, and can apply lost signal projection factors to recover the lost attribution signal.

In some embodiments, the odds ratio test can be used as a validation mechanism to verify the accuracy of the attribution measurements produced by the multi-touch attribution module 111. By comparing the attributed conversions against the baseline expectation based on random duplication, the odds ratio test can identify systematic issues in the attribution methodology that may be causing under-attribution or over-attribution. The results of the odds ratio test can be provided to a user device (e.g., client device 120A-Z) for presentation in a user interface (e.g., in a dashboard displayed via user interface 124A-Z), enabling advertisers to assess the reliability of their attribution measurements.

In some embodiments, the visualization illustrated in FIG. 4 can be displayed in the user interface to help advertisers understand the relationship between campaign reach and conversions. The campaign reach 403 of 22% indicates that 22% of the overall population was reached by the advertising campaign. The distribution of conversions 401 inside and outside the campaign reach 403 boundary illustrates the proportion of conversions that can be attributed to users who were exposed to the campaign versus users who were not exposed. This visualization can help advertisers assess whether their attribution system is accurately connecting advertising impressions to conversions based on the expected relationship between reach and attributed conversions.

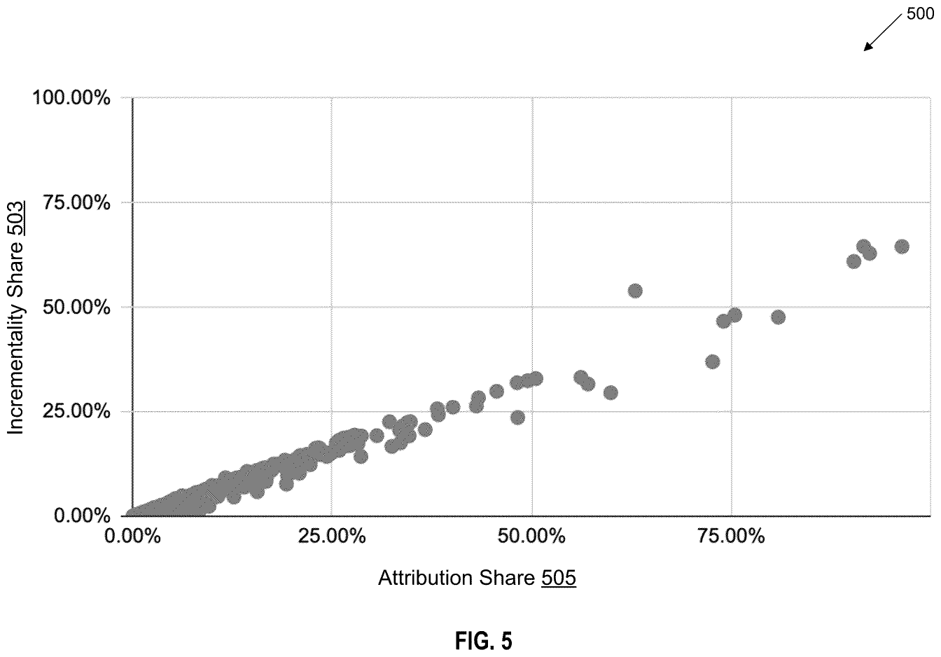

FIG. 5 depicts a scatter chart 500 illustrating the relationship between attribution share 505 and incrementality share 503, in accordance with one or more aspects of the present disclosure. The scatter chart 500 displays a plurality of data points representing campaign measurements, with the attribution share 505 plotted along the horizontal X-axis and the incrementality share 503 plotted along the vertical Y-axis. Both axes range from 0.00% to 100.00%, with gridlines at 25.00%, 50.00%, and 75.00% intervals.

The data points in the scatter chart 500 demonstrate a positive correlation between the attribution share 505 and the incrementality share 503. The majority of data points are clustered along a diagonal pattern extending from the lower left region of the scatter chart 500 toward the upper right region. At lower values of attribution share 505, the data points are tightly clustered near the origin, with incrementality share 503 values generally below 25.00% when attribution share 505 is below approximately 25.00%. As the attribution share 505 increases toward the 50.00% range, the incrementality share 503 values correspondingly increase, with data points showing incrementality share 503 values ranging from approximately 25.00% to 35.00%. At higher values of attribution share 505 approaching 75.00% to 100.00%, the data points exhibit incrementality share 503 values ranging from approximately 40.00% to 70.00%, with some dispersion visible among the data points in this region.

In some embodiments, the data points in the scatter chart 500 represent measurements from over thousands of campaigns analyzed by the multi-touch attribution module 111. The scatter chart 500 demonstrates a positive correlation between the attribution share 505 and the incrementality share 503, validating the relationship between attribution and incrementality that underlies the multi-touch attribution techniques described herein. Based on analysis of the campaign measurements, approximately 60% of attributed impressions are incremental.

In some embodiments, the multi-touch attribution module 111 can leverage the relationship illustrated in scatter chart 500 to use attribution as a leading indicator for incrementality. Attribution can be available nearly instantaneously, while incrementality analysis may take approximately four days of computation to process patterns of exposure and conversion for a campaign. Because attribution and incrementality are closely related as demonstrated in scatter chart 500, the attribution component 136 can provide preliminary attribution estimates based on attribution measurements while the incrementality engine 131 performs the more computationally intensive incrementality analysis. Once the incrementality count is determined, the attribution component 136 can adjust the attribution measurement to fit the observed incrementality.

In some embodiments, the scatter chart 500 illustrates that incrementality share 503 values are consistently lower than their corresponding attribution share 505 values. This is because incrementality represents the subset of attributable conversions that were caused by the advertisement (the “but for” standard), while attribution represents all conversions that occur within a lookback window following advertising impressions. The baseline conversions are not measured as incremental by the statistical machine learning analysis. The incremental analysis only evaluates attributed conversions, therefore attribution within the lookback window forms the upper-bound of incremental conversions.

FIG. 6A depicts a frequency to lift response function (FLIRF) graph 600 illustrating the relationship between advertising frequency and cumulative lift, in accordance with one or more aspects of the present disclosure. The frequency to lift response function graph 600 includes a FLIRF axis 601 representing the vertical Y-axis and a frequency axis 603 representing the horizontal X-axis. The FLIRF axis 601 displays values ranging from 0 to 7,000, while the frequency axis 603 displays values ranging from 0 to 100.

The frequency to lift response function graph 600 displays a solid curved line representing the FLIRF values and a series of dots representing cumulative lift data points. Cumulative lift can refer to the total increase in conversions attributable to advertising impressions accumulated up to a given frequency level. The curved line and cumulative lift data points demonstrate a diminishing returns pattern, where the cumulative lift increases rapidly at lower frequencies and then gradually flattens as frequency increases along the frequency axis 603. A placement frequency 605 is indicated by a large circular marker positioned at a lower frequency value on the curve, representing a current frequency level for an advertisement placement. A point of diminishing returns 607 is indicated by a vertical line extending from the frequency axis 603 upward through the curve, marking the frequency level beyond which additional advertising impressions yield minimal incremental conversions. The placement frequency 605 is positioned to the left of the point of diminishing returns 607, indicating that the placement is still on the steep portion of the curve where marginal returns from additional advertising investment remain relatively high.

In some embodiments, the multi-touch attribution module 111 can analyze the position of the placement frequency 605 relative to the point of diminishing returns 607 to determine whether additional advertising investment in the placement would produce meaningful incremental conversions. When the placement frequency 605 is positioned to the left of the point of diminishing returns 607, as illustrated in frequency to lift response function graph 600, the slope of the curve at the placement frequency 605 is relatively steep, indicating that purchasing additional frequency would produce significant marginal conversions. The attribution component 136 can recommend increasing investment in placements exhibiting this characteristic to maximize incremental conversions.

FIG. 6B depicts a graph 650 illustrating a frequency to lift response function for multi-touch attribution, in accordance with one or more aspects of the present disclosure. The graph 650 includes a FLIRF axis 651 representing the frequency to lift impact response function values along the vertical Y-axis, and a frequency axis 653 representing the frequency of advertising impressions along the horizontal X-axis. The FLIRF axis 651 displays values ranging from 0 to 7,000, while the frequency axis 653 displays values ranging from 0 to 100.

The graph 650 displays a curve labeled as FLIRF that demonstrates a diminishing returns pattern, where the cumulative lift increases rapidly at lower frequencies and then gradually flattens as frequency increases. Data points labeled as cumulative lift are plotted along the curve, representing empirically observed cumulative lift values at various frequency levels. A placement frequency 655 is indicated on the graph 650 by a large circular marker positioned on the curve at approximately frequency 25 and FLIRF value 5,500, representing the current frequency level for an advertisement placement. A point of diminishing returns 657 is indicated by a vertical line extending from the frequency axis 653 at approximately frequency 12, marking the threshold beyond which additional advertising impressions yield substantially reduced marginal returns. The curve shows that at frequencies below the point of diminishing returns 657, the slope of the curve is relatively steep, indicating higher marginal returns from additional advertising investment, while at frequencies above the point of diminishing returns 657, the curve substantially flattens, indicating that additional spending would yield minimal incremental conversions.

In some embodiments, the placement frequency 655 in graph 650 is positioned to the right of the point of diminishing returns 657, indicating that the placement has exceeded the threshold where additional advertising investment produces meaningful incremental conversions. When the placement frequency 655 is positioned to the right of the point of diminishing returns 657, as illustrated in graph 650, the slope of the curve at the placement frequency 655 is relatively flat, indicating that purchasing additional frequency would produce minimal marginal conversions. The attribution component 136 can recommend reducing investment in placements exhibiting this characteristic and reallocating budget to placements that are still on the steep portion of the curve, such as the placement illustrated in frequency to lift response function graph 600 of FIG. 6A.

In some embodiments, the multi-touch attribution module 111 can compare the scenarios illustrated in FIGS. 6A and 6B to identify optimization opportunities across multiple advertisement placements. A first placement may exhibit the characteristics shown in FIG. 6A, where the placement frequency 605 is below the point of diminishing returns 607, while a second placement may exhibit the characteristics shown in FIG. 6B, where the placement frequency 655 is above the point of diminishing returns 657. Even if the second placement has a lower average cost per action than the first placement, the marginal cost per action for the second placement may be higher because the second placement is past the point of diminishing returns. The multi-touch attribution module 111 can generate recommendations to shift budget from the second placement to the first placement to maximize incremental conversions for the same advertising spend.

In some embodiments, the normalization component 135 can use the frequency to lift response functions illustrated in FIGS. 6A and 6B to apply frequency normalization when comparing different advertisement placements. Because different placements may be at different points on their respective diminishing returns curves, comparing two placements to determine which is more impactful should be done using a normalized frequency (such as relative impact at a frequency of 1.0). The normalization component 135 can normalize the attribution and incrementality measurements to the same frequency level to enable like-for-like comparison of placements operating at different frequency levels, as described with respect to FIG. 1.

In some embodiments, the data points plotted in FIGS. 6A and 6B can be derived from the incrementality measurements determined by the incrementality engine 131 using the post-hoc comparative analysis described with respect to FIGS. 1-2. The incrementality engine 131 can determine the incremental lift at various frequency levels by comparing the conversion rates of users exposed to the advertisement at each frequency level against the conversion rates of the control group (e.g., users exposed to placebo tags as described with respect to FIG. 3). The resulting data points can be used to fit the frequency to lift response function curves, enabling the multi-touch attribution module 111 to calculate marginal cost per action at any frequency level along the curve.

FIG. 7 is a block diagram of a system 700 for AI model training and inference for multi-touch attribution, in accordance with one or more aspects of the present disclosure. The system 700 depicts the relationship between training data inputs 701, the AI training component 711, the trained AI model 707, and the inference process used by the multi-touch attribution module 111 described with respect to FIG. 1.

In some embodiments, the system 700 can include a training data inputs 701, an AI training component 711, an AI model 707, AI model input 709, and/or an AI model output 710. The training data inputs 701 can contain data used for training the AI model 707. The training data inputs 701 may correspond to data stored in data store 140 of FIG. 1, and can include tag data 142, conversion event data 143, incrementality measurement data 144, and/or AI model training data 148. The training data inputs 701 are provided data to the AI training component 711.

In some embodiments, the AI training component 711 can include a training dataset generator 703 and a training module 705. The training dataset generator 703 receives data from the training data inputs 701 and generates training datasets suitable for training the AI model 707. In some embodiments, the training dataset generator 703 can generate training data that includes tags associated with conversion events, entity identifiers, and/or corresponding incrementality measurements determined by the incrementality engine 131 using the post-hoc quasi-experimental design described with respect to FIG. 2. The training datasets can include sets of training inputs (e.g., plurality of tags and entity identifiers) and target outputs (e.g., incrementality counts corresponding to entity tags).

In some embodiments, the training module 705 can use the training datasets generated by the training dataset generator 703 to train the AI model 707. In some embodiments, the training module 705 can train the AI model 707 using at least two of bootstrapping, shuffle sampling, or random duplication techniques. The bootstrap method with shuffle sampling for signal robustness measures the degree to which the advertiser's tag is more associated with the KPI compared to a random sample of other tags (e.g., placebo tags 303A-Z as described with respect to FIG. 3). The shuffle sampling of different tag combinations can develop a highly reliable measure of the true incremental impact of advertising.

In some embodiments, the training module 705 can train the AI model 707 to be or include a linear regression model, a neural network, a decision tree, a support vector machine, a gradient boosting model, and/or other suitable model architectures configured to fit the input features to the incrementality data and determine a best fit prediction of incrementality counts. The AI training component 711 con provide the trained model parameters and configurations to the AI model 707 upon completion of training.

In some embodiments, the training module 705 can gather data during a first time period of a planned advertisement campaign (e.g., during the first week of the campaign) and use the data to train or fine-tune a campaign-specific AI model. It can take approximately four days of computation to process patterns of exposure and conversion for a campaign, feeding on the first week of campaign data, after which an incrementality model becomes available. The training module 705 can then configure the AI model 707 to run for the remainder of the advertisement campaign to generate incrementality counts, in embodiments.

In some embodiments, the training module 705 can leverage historical campaign data to establish benchmark learning that serves as prior knowledge for new campaigns. The training module 705 can perform computationally intensive benchmark analysis after campaigns complete, analyzing patterns of exposure and conversion across multiple campaigns to develop normative models. The benchmark learning can then be used as priors in a Bayesian model for subsequent campaigns, enabling faster calculation and delivery of results in near real-time.

In some embodiments, the trained AI model 707 receives trained parameters from the AI training component 711 and is configured to process inputs and generate outputs for multi-touch attribution analysis. The AI model 707 receives data from AI model input 709, which can contain input data for inference operations. The AI model input 709 may include tags associated with conversion events, entity identifiers, and/or other data relevant to determining incrementality counts. In some embodiments, the AI model input 709 can correspond to tracking data 141 and/or tag data 142 received from a tracking pixel associated with a KPI, as described with respect to FIG. 1.

The AI model 707 processes the data received from the AI model input 709 and generates the AI model output 710. The AI model output 710 contains the results of the AI model inference, which may include incrementality counts corresponding to tags associated with entities. In some embodiments, the AI model 707 can receive, as input, the tags associated with a particular KPI or conversion event and an identifier identifying the entity associated with the KPI or conversion event. The AI model 707 can provide, as output, an incrementality measurement for the tag associated with the entity. The AI model output 710 can receive and store the output generated by the AI model 707.

In some embodiments, the output data from the AI model 707 can be used to further refine and improve the training process. This feedback mechanism enables continuous improvement of the AI model 707 as more data is collected and processed during advertising campaigns. In some embodiments, as more data is collected throughout the campaign, the AI training component 711 can continue to fine-tune the AI model 707 and adjust the attribution estimates accordingly.

In some embodiments, the feedback loop enables the system 700 to use attribution as a leading indicator for incrementality. Attribution can be available nearly instantaneously, while incrementality analysis may take approximately four days of computation. Because attribution and incrementality are closely related (as illustrated in scatter chart 500 of FIG. 5, approximately 60% of attributed impressions are incremental), the system 700 can provide preliminary attribution estimates based on attribution measurements while the more computationally intensive incrementality analysis is being performed. Once the incrementality count is determined, the attribution component 136 can adjust the attribution measurement to fit the observed incrementality, and the feedback loop can update the AI model 707 weights based on the final incrementality results to improve future predictions.

In some embodiments, the AI model output 710 can be provided to the attribution component 136 of the multi-touch attribution module 111 for further processing. The attribution component 136 can combine the incrementality count from the AI model output 710 with a baseline attribution value to determine total attributed events. The attribution component 136 can then apply spillover corrections (using spillover effect data 146) and lost signal adjustments (using lost signal projection data 147) to determine the final attribution measurement.

The system 700 illustrates the ability to train the AI model 707 on a high-quality signal of incrementality determined by the post-hoc quasi-experimental design. Unlike conventional attribution approaches that train models on forward-tracking attribution data (which suffers from lost signal problems), the system 700 trains the AI model 707 on incrementality measurements that account for the true causal effect of advertising. This training approach enables the AI model 707 to empirically measure the differential contribution of each advertising touch to a conversion event, rather than imposing fixed weighting schemes (such as equal weighting or time-based decay) that can significantly distort the true contribution of each touch.

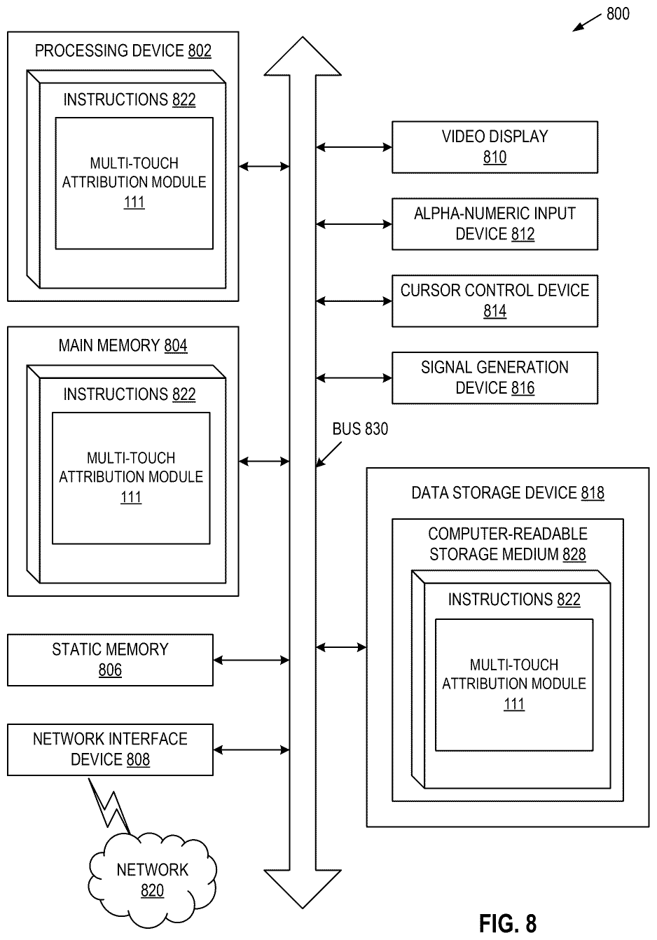

FIG. 8 depicts a block diagram of an example computing system 800 operating in accordance with one or more aspects of the present disclosure. In various illustrative examples, computer system 800 may correspond to any of the computing devices within system architecture 100 of FIG. 1. In one implementation, the computer system 800 may be the server device 112.

In certain implementations, computer system 800 may be connected (e.g., via a network, such as a Local Area Network (LAN), an intranet, an extranet, or the Internet) to other computer systems. Computer system 800 may operate in the capacity of a server or a client computer in a client-server environment, or as a peer computer in a peer-to-peer or distributed network environment. Computer system 800 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 800 may include a processing device 802, a volatile memory 804 (e.g., random access memory (RAM)), a non-volatile memory 806 (e.g., read-only memory (ROM) or electrically-erasable programmable ROM (EEPROM)), and a data storage device 816, which may communicate with each other via a bus 808.

Processing device 802 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 800 may further include a network interface device 822. Computer system 800 also may include a video display unit 810 (e.g., an LCD), an alphanumeric input device 812 (e.g., a keyboard), a cursor control device 814 (e.g., a mouse), and a signal generation device 820.

Data storage device 816 may include a non-transitory computer-readable storage medium 824 on which may store instructions 826 encoding any one or more of the methods or functions described herein, including instructions implementing multi-touch attribution module 111 of FIG. 1 for implementing the methods described herein.

Instructions 826 may also reside, completely or partially, within volatile memory 804 and/or within processing device 802 during execution thereof by computer system 800, hence, volatile memory 804 and processing device 802 may also constitute machine-readable storage media.

While computer-readable storage medium 824 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In the foregoing description, numerous details are set forth. It will be apparent, however, to one of ordinary skill in the art having the benefit of this disclosure, that the present disclosure can be practiced without these specific details. In some instances, well-known structures and devices are shown in block diagram form, rather than in detail, in order to avoid obscuring the present disclosure.

Some portions of the detailed description have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “identifying”, “determining”, “generating”, “assigning”, “inputting”, “selecting”, “training”, “moving”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

For simplicity of explanation, the methods are depicted and described herein as a series of acts. However, acts in accordance with this disclosure can occur in various orders and/or concurrently, and with other acts not presented and described herein. Furthermore, not all illustrated acts can be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Certain implementations of the present disclosure also relate to an apparatus for performing the operations herein. This apparatus can be constructed for the intended purposes, or it can comprise a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Reference throughout this specification to “one implementation” or “an implementation” means that a particular feature, structure, or characteristic described in connection with the implementation is included in at least one implementation. Thus, the appearances of the phrase “in one implementation” or “in an implementation” in various places throughout this specification are not necessarily all referring to the same implementation. In addition, the term “or” is intended to mean an inclusive “or” rather than an exclusive “or.” Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

What is claimed is:

1. A method comprising:
receiving, from a tracking pixel associated with a key performance indicator (KPI), tracking data comprising a plurality of tags, wherein the KPI is associated with an entity, wherein a first tag of the plurality of tags is associated with the entity, and wherein a second tag of the plurality of tags is associated with a second entity;
determining, using a post-hoc comparative analysis, an incrementality count corresponding to the first tag based on a comparison of a first conversion rate associated with the first tag and a second conversion rate associated with the second tag;
determining at least one of a spillover effect, based on a pairwise duplication of the first tag with the second tag, or a lost signal measurement corresponding to the first tag;
determining an attribution measurement by applying the at least one of the spillover effect or the lost signal measurement to the incrementality count; and
providing, to a user device, at least one of the attribution measurement or the incrementality count.

2. The method of claim 1, wherein determining the spillover effect further comprises:
performing the pairwise duplication analysis of the first tag with each of a plurality of other tags in the plurality of tags to identify overlapping exposures between the entity and one or more other entities.

3. The method of claim 1, wherein determining the lost signal measurement comprises:
determining a traditional incrementality count using a forward-tracking attribution method; and
determining a difference between the incrementality count and the traditional incrementality count, wherein the difference represents the lost signal measurement.

4. The method of claim 1, further comprising:
determining a lost signal projection factor based on the lost signal measurement; and
scaling the attribution measurement by the lost signal projection factor to account for untrackable interactions.

5. The method of claim 1, wherein determining the lost signal measurement comprises:
determining a first metric value for a first subset of the plurality of tags, wherein the first subset corresponds to the entity;
determining a second metric value for a second subset of the plurality of tags, wherein the second subset does not correspond to the entity; and
determining a difference between the first metric value and the second metric value.

6. The method of claim 1, wherein determining the incrementality count comprises:
providing, as input to an artificial intelligence (AI) model, the plurality of tags and an identifier of the entity, wherein the AI model is trained to output a corresponding incrementality count corresponding to each tag in the plurality of tags; and
receiving, as output from the AI model, the incrementality count corresponding to the first tag.

7. The method of claim 6, wherein the AI model combines at least two of bootstrapping, shuffle sampling, or random duplication.

8. The method of claim 6, wherein the AI model comprises at least one of a linear regression model, a neural network, a decision tree, a support vector machine, or a gradient boosting model configured to fit input features to incrementality data.

9. The method of claim 6, further comprising:
gathering campaign data during a first time period of a campaign;
performing fine-tuning of the AI model based on the campaign data gathered during the first time period; and
executing the trained AI model for a remainder of the campaign to generate incrementality counts.

10. The method of claim 1, wherein determining the incrementality count comprises:
applying bootstrap methods with shuffle sampling to the plurality of tags to measure a degree to which the first tag is more associated with the KPI compared to a random sample of other tags in the plurality of tags.

11. The method of claim 10, wherein the shuffle sampling comprises randomly duplicating the plurality of tags to confirm that the first tag is statistically higher than the second tag to an extent corresponding to an incremental impact from media items associated with the first tag.

12. The method of claim 1, wherein the post-hoc comparative analysis comprises at least one of a post-hoc randomized controlled test using randomized sampling of concurrent campaigns, or a post-hoc quasi-experimental design comprising matching control groups based on content media size and targeting parameters using entropy balancing or iterative proportionate fit weighting.

13. The method of claim 1, wherein the second tag corresponds to a concurrent campaign from the second entity different from the entity, and wherein the second tag serves as a control in the post-hoc comparative analysis.

14. The method of claim 1, further comprising:
determining a normalization factor based on empirical analysis of historical campaigns analyzed using both a person-level grain and a regional-level grain, wherein the normalization factor accounts for a difference in attribution signal between the person-level grain and the regional-level grain; and
normalizing the plurality of tags for measurement grain differences between the person-level digital data and the regional-level broadcast data by applying the normalization factor to the plurality of tags.

15. The method of claim 1, further comprising:
determining a privacy consent projection factor based on a percentage of users who opted in to tracking versus a percentage of users who opted out of tracking; and
applying the privacy consent projection factor to the attribution measurement to account for signal loss due to privacy opt-outs.

16. The method of claim 1, further comprising:
determining a baseline attribution by multiplying a reach of media items associated with the first tag by a total number of conversion events during a lookback window;
wherein determining the attribution measurement comprises combining the incrementality count with the baseline attribution to determine total attributed events.

17. The method of claim 16, wherein the reach corresponds to a rolling reach calculated over the lookback window.

18. The method of claim 1, further comprising:
generating a recommendation to increase the attribution measurement based on at least one of: one or more targets, one or more time periods, or one or more channels; and
providing, to the user device, the recommendation.

19. A system comprising:
a memory device; and
a processing device operatively coupled to the memory device, wherein the processing device is configured to:
receive, from a tracking pixel associated with a key performance indicator (KPI), tracking data comprising a plurality of tags, wherein the KPI is associated with an entity, wherein a first tag of the plurality of tags is associated with the entity, and wherein a second tag of the plurality of tags is associated with a second entity;
determine, using a post-hoc comparative analysis, an incrementality count corresponding to the first tag based on a comparison of a first conversion rate associated with the first tag and a second conversion rate associated with the second tag;
determine at least one of a spillover effect based on a pairwise duplication of the first tag with the second tag, or a lost signal measurement corresponding to the first tag;
determine an attribution measurement by applying the at least one of the spillover effect or the lost signal measurement to the incrementality count; and
provide, to a user device, at least one of the attribution measurement or the incrementality count.

20. A non-transitory computer-readable storage medium comprising instructions that, when executed by a processing device, cause the processing device to:
receive, from a tracking pixel associated with a key performance indicator (KPI), tracking data comprising a plurality of tags, wherein the KPI is associated with an entity, wherein a first tag of the plurality of tags is associated with the entity, and wherein a second tag of the plurality of tags is associated with a second entity;
determine, using a post-hoc comparative analysis, an incrementality count corresponding to the first tag based on a comparison of a first conversion rate associated with the first tag and a second conversion rate associated with the second tag;
determine at least one of a spillover effect based on a pairwise duplication of the first tag with the second tag, or a lost signal measurement corresponding to the first tag;
determine an attribution measurement by applying the at least one of the spillover effect or the lost signal measurement to the incrementality count; and
provide, to a user device, at least one of the attribution measurement or the incrementality count.
